(19) United States
(12) Patent Application Publication
(10) Pub. No.: US 2024/0008477 A1
(43) Pub. Date: Jan. 11, 2024

(54) ADHESIVE, EXTRUDABLE ABOVE-GROUND TERMITE BAIT AND METHODS FOR MANUFACTURING SAME

(71) Applicant: DOW AGROSCIENCES LLC, Indianapolis, IN (US)

(72) Inventors: Phil RANLY, Indianapolis, IN (US); Neil A. SPOMER, Carmel, IN (US); Jacy MACCHIA, Indianapolis, IN (US); Mary RUSHTON, Indianapolis, IN (US); Joseph J. DEMARK, Westfield, IN (US); Dave MAURER, Indianapolis, IN (US); Srishti KHURANA, Indianapolis, IN (US)

(21) Appl. No.: 18/006,630

(22) PCT Filed: Jul. 28, 2021
(86) PCT No.: PCT/US2021/043448

§ 371 Date: Jan. 24, 2023

Related U.S. Application Data
(60) Provisional application No. 63/059,541, filed on Jul. 31, 2020.

(51) Int. Cl. A01N 25/00; A01N 25/10; A01N 47/34; A01N 43/80; A01P 7/04

(52) U.S. Cl. CPC A01N 25/006; A01N 25/10; A01N 47/34; A01N 43/80; A01P 7/04

(57) ABSTRACT

A composition, manufacturing methods, and method of use for controlling wood-destroying pests are disclosed. The composition includes an active ingredient that is a chitin synthesis inhibitor such as noviflumuron, a binder, a filler that includes cellulosic food material palatable to termites, and a solvent. The composition is a viscous, adhesive bait. A method for manufacturing the adhesive bait includes mixing water and binder in heated vessel, dry blending active ingredient and filler, mixing the blended ingredients in the vessel at high temperature, and reducing temperature while mixing. The method for use includes identifying an active above-ground termite infestation, applying adhesive bait to the infestation site, and covering the bait. Applying the adhesive bait may include extruding the bait from an applicator tool such as a caulk gun. Other embodiments are described and claimed.

### CROSS-REFERENCE TO RELATED APPLICATION

The present application claims the benefit of U.S. Provisional Patent Application No. 63/059,541, filed on Jul. 31, 2020, the entirety of which is incorporated herein by reference.

### TECHNICAL FIELD

The present disclosure relates generally to materials for controlling pests, and, more specifically, to materials that are palatable to a wood-destroying pest species and also pesticidal to the pest species.

### BACKGROUND

The protection of wooden structures and plants from damage caused by pests has been an area of particular interest for many years, and the removal of pests from areas occupied by humans, livestock, and crops has long been a challenge. Pests of frequent concern include various types of insects and rodents. Subterranean termites are a particularly troublesome type of pest with the potential to cause severe damage to wooden structures. Various schemes have been proposed to eliminate termites and certain other harmful pests of both the insect and noninsect variety. In one approach, pest control relies on the blanket application of chemical pesticides in the area to be protected. However, as a result of environmental regulations, this approach is becoming less desirable.

Recently, advances have been made to provide for the targeted delivery of pesticide chemicals. One example directed to termite control is the SENTRICON® Termite Colony Elimination System of Corteva Agriscience that has a business address of 9330 Zionsville Road, Indianapolis, Ind. In this system, a number of units each having a termite edible material, are placed at least partially in the ground about a dwelling to be protected. The units are inspected routinely by a pest control service for the presence of termites, and inspection data is recorded with reference to a unique barcode label associated with each unit. If termites are found in a given unit, a bait is installed that contains a slow-acting pesticide intended to be carried back to the termite nest to eradicate the colony. U.S. Pat. No. 10,375,957 to Su is another example that describes a fluid termite bait with low viscosity (below about 100 Pa·s).

Formosan termites (C. formosanus) are an invasive species in North America that feed on live trees, among other things. Such invasive termites are known to kill or otherwise cause extensive damage to natural trees, ornamental trees, and crop trees. Typical termite treatments include spot contact insecticides such as Termidor®, available commercially from BASF. Such contact insecticides will kill individual termites on contact, but do not eliminate termite colonies.

### SUMMARY

According to one aspect of the disclosure includes a composition of matter including an active ingredient comprising a chitin synthesis inhibitor; a binder; a filler comprising a cellulosic food material palatable to termites; and a solvent. The composition has a viscosity of at least about 200 Pa·s. In some embodiments, the composition has a viscosity of between about 200 Pa·s and 500 Pa·s. In some embodiments, the composition has a viscosity of between about 400 Pa·s and 500 Pa·s. In some embodiments, the composition has a viscosity of between about 200 Pa·s and 3000 Pa·s. In some embodiments, the composition has a viscosity that is adapted to flow through an applicator device. In some embodiments, the applicator device may include a caulk gun and cartridge assembly or a squeeze tube.

In some embodiments, the active ingredient comprises noviflumuron. In some embodiments, the binder comprises methylcellulose. In some embodiments, the filler comprises alpha cellulose. In some embodiments, the solvent comprises water.

In some embodiments, the active ingredient comprises hexaflumuron.

In some embodiments, the composition further includes a biocide. In some embodiments, the biocide comprises an aqueous dipropylene glycol solution of 1,2-benzisothiazolin-3-one.

In some embodiments, the active ingredient comprises between about 0.1% and 0.2% by weight of the composition. In some embodiments, the binder combined with the filler comprise between about 24% and 30% by weight of the composition.

In some embodiments, the active ingredient comprises about 0.125% by weight of the composition; the binder comprises about 1.8% by weight of the composition; and the filler comprises about 21.675% by weight of the composition. In some embodiments, the composition further includes a biocide that comprises about 0.2% by weight of the composition. In some embodiments, the solvent comprises about 76.2% by weight of the composition.

According to another aspect, a method includes heating water in a vessel to a first predetermined temperature; adding a biocide to the water in the vessel; adding a binder to the water in the vessel; mixing the biocide and the binder in the vessel at the first predetermined temperature to generate a first component, wherein the first predetermined temperature is above a gelation temperature of the binder; dry blending an active ingredient and a filler to generate a second component, wherein the active ingredient comprises a chitin synthesis inhibitor; adding the second component to the first component in the vessel at the first predetermined temperature; mixing the first component and the second component in the vessel; and reducing temperature of the first component and the second component from the first predetermined temperature to a second predetermined temperature while mixing the first component and the second component, wherein the second predetermined temperature is below the gelation temperature of the binder. In some embodiments, the binder comprises methylcellulose, the filler comprises alpha cellulose, and the active ingredient comprises noviflumuron.

In some embodiments, the first predetermined temperature comprises between about 82° C. to 85° C. In some embodiments, the first predetermined temperature comprises about 85° C. In some embodiments, the second predetermined temperature comprises between about 43° C. to 45° C. In some embodiments, the second predetermined temperature comprises about 43° C. or less.

In some embodiments, mixing the biocide and the binder in the vessel includes mixing at a first mixing speed; and mixing the first component and the second component in the vessel includes mixing at a second mixing speed, wherein the second mixing speed is higher than the first mixing speed. In some embodiments, the first mixing speed is about 7 revolutions per minute (RPM). In some embodiments, the first mixing speed is between about 10 to 35 RPM. In some embodiments, the second mixing speed is about 60 RPM. In some embodiments, the second mixing speed is about 300 RPM.

In some embodiments, the method further includes stopping active temperature control of the vessel in response to reducing temperature to the second predetermined temperature; and mixing the first component and the second component after stopping the active temperature control. In some embodiments, mixing the biocide and the binder in the vessel includes mixing for about five minutes; and mixing the first component and the second component in the vessel includes: mixing for about two minutes after adding the second component to the first component; mixing for about 10-13 minutes while reducing the temperature; and mixing for about 17-20 minutes after stopping active temperature control.

In some embodiments, the vessel comprises a high shear mixer. In some embodiments, the vessel comprises a plow baffle mixer. In some embodiments, the vessel comprises a Cowles blade mixer and a pitched turbine mixer.

According to another aspect, an adhesive bait is manufactured by a method including heating water in a vessel to a first predetermined temperature; adding a biocide to the water in the vessel; adding a binder to the water in the vessel; mixing the biocide and the binder in the vessel at the first predetermined temperature to generate a first component, wherein the first predetermined temperature is above a gelation temperature of the binder; dry blending an active ingredient and a filler to generate a second component, wherein the active ingredient comprises a chitin synthesis inhibitor; adding the second component to the first component in the vessel at the first predetermined temperature; mixing the first component and the second component in the vessel; and reducing temperature of the first component and the second component from the first predetermined temperature to a second predetermined temperature while mixing the first component and the second component, wherein the second predetermined temperature is below the gelation temperature of the binder. In some embodiments, the binder comprises methylcellulose, the filler comprises alpha cellulose, and the active ingredient comprises noviflumuron.

In some embodiments, the first predetermined temperature comprises between about 82° C. to 85° C. In some embodiments, the first predetermined temperature comprises about 85° C. In some embodiments, the second predetermined temperature comprises between about 43° C. to 45° C. In some embodiments, the second predetermined temperature comprises about 43° C. or less.

In some embodiments, mixing the biocide and the binder in the vessel includes mixing at a first mixing speed; and mixing the first component and the second component in the vessel includes mixing at a second mixing speed, wherein the second mixing speed is higher than the first mixing speed. In some embodiments, the first mixing speed is about 7 revolutions per minute (RPM). In some embodiments, the first mixing speed is between about 10 to 35 RPM. In some embodiments, the second mixing speed is about 60 RPM. In some embodiments, the second mixing speed is about 300 RPM.

In some embodiments, the adhesive bait is manufactured by a method further including stopping active temperature control of the vessel in response to reducing temperature to the second predetermined temperature; and mixing the first component and the second component after stopping the active temperature control. In some embodiments, mixing the biocide and the binder in the vessel includes mixing for about five minutes; and mixing the first component and the second component in the vessel includes: mixing for about two minutes after adding the second component to the first component; mixing for about 10-13 minutes while reducing the temperature; and mixing for about 17-20 minutes after stopping active temperature control.

In some embodiments, the vessel comprises a high shear mixer. In some embodiments, the vessel comprises a plow baffle mixer. In some embodiments, the vessel comprises a Cowles blade mixer and a pitched turbine mixer.

According to another aspect, a method includes identifying an active above-ground termite infestation at an infestation site; applying an adhesive termite bait including an active ingredient to the infestation site, wherein the active ingredient comprises a chitin synthesis inhibitor; and covering the adhesive termite bait with a nonpermeable cover in response to applying the adhesive bait.

In some embodiments, applying the adhesive termite bait includes extruding the adhesive termite bait from an applicator tool to the infestation site. In some embodiments, the applicator tool comprises a caulk gun and the adhesive bait is packaged in a cartridge coupled to the caulk gun. In some embodiments, the applicator tool comprises a squeeze tube with an applicator tip, wherein the adhesive bait is packaged in the squeeze tube.

In some embodiments, applying the adhesive termite bait includes (i) opening a package containing the adhesive bait to expose the adhesive bait and (ii) adhering the adhesive bait to the infestation site.

In some embodiments, the infestation site comprises a tree. In some embodiments, applying the adhesive termite bait includes drilling a hole in the tree at the infestation site, wherein the hole is in communication with a termite gallery; and injecting the adhesive bait into the termite gallery via the hole.

In some embodiments, the infestation site comprises a structure.

In some embodiments, the nonpermeable cover comprises a plastic sheet or a plastic plug.

In some embodiments, the method further comprises attaching a bait package to the adhesive bait in response to applying the adhesive bait, wherein the bait package comprises a solid matrix bait that includes the active ingredient.

According to another aspect, a method includes heating water in a vessel to a first predetermined temperature; adding a biocide to the water in the vessel; adding an active ingredient concentrate to the water in the vessel, wherein the active ingredient concentrate comprises a liquid suspension of a chitin synthesis inhibitor; adding a binder to the water in the vessel; mixing the biocide, the active ingredient, and the binder in the vessel at the first predetermined temperature, wherein the first predetermined temperature is above a gelation temperature of the binder; adding a filler to the biocide, the active ingredient, and the binder in the vessel at the first predetermined temperature; mixing the biocide, the active ingredient, the binder, and the filler in the vessel; and reducing temperature of the biocide, the active ingredient, the binder, and the filler from the first predetermined temperature to a second predetermined temperature while mixing the biocide, the active ingredient, the binder, and the filler, wherein the second predetermined temperature is below the gelation temperature of the binder. In some embodiments, the binder comprises methylcellulose, the filler comprises alpha cellulose, and the active ingredient comprises noviflumuron.

In some embodiments, the first predetermined temperature comprises between about 82° C. to 85° C. In some embodiments, the first predetermined temperature comprises about 85° C. In some embodiments, the second predetermined temperature comprises between about 43° C. to 45° C. In some embodiments, the second predetermined temperature comprises about 43° C. or less.

In some embodiments, mixing the biocide, the active ingredient, and the binder in the vessel includes mixing at a first mixing speed; and mixing the biocide, the active ingredient, the binder, and the filler in the vessel includes mixing at a second mixing speed, wherein the second mixing speed is higher than the first mixing speed. In some embodiments, the first mixing speed is about 5.7 revolutions per minute (RPM). In some embodiments, the first mixing speed is between about 10 to 35 RPM. In some embodiments, the second mixing speed is about 69.6 RPM. In some embodiments, the second mixing speed is about 166 RPM.

In some embodiments, the method further includes stopping active temperature control of the vessel in response to reducing temperature to the second predetermined temperature; and mixing the biocide, the active ingredient, the binder, and the filler after stopping the active temperature control. In some embodiments, mixing the biocide, the active ingredient, and the binder in the vessel comprises mixing for about 12.5 minutes; and mixing the biocide, the active ingredient, the binder, and the filler in the vessel comprises mixing for about 60-90 minutes while reducing the temperature.

In some embodiments, the vessel comprises a high shear mixer. In some embodiments, the vessel comprises a plow baffle mixer. In some embodiments, the vessel comprises a Cowles blade mixer and a pitched turbine mixer.

According to another aspect, an adhesive bait manufactured by a method including heating water in a vessel to a first predetermined temperature; adding a biocide to the water in the vessel; adding an active ingredient concentrate to the water in the vessel, wherein the active ingredient concentrate comprises a liquid suspension of a chitin synthesis inhibitor; adding a binder to the water in the vessel; mixing the biocide, the active ingredient, and the binder in the vessel at the first predetermined temperature, wherein the first predetermined temperature is above a gelation temperature of the binder; adding a filler to the biocide, the active ingredient, and the binder in the vessel at the first predetermined temperature; mixing the biocide, the active ingredient, the binder, and the filler in the vessel; and reducing temperature of the biocide, the active ingredient, the binder, and the filler from the first predetermined temperature to a second predetermined temperature while mixing the biocide, the active ingredient, the binder, and the filler, wherein the second predetermined temperature is below the gelation temperature of the binder. In some embodiments, the binder comprises methylcellulose, the filler comprises alpha cellulose, and the active ingredient comprises noviflumuron.

In some embodiments, the first predetermined temperature comprises between about 82° C. to 85° C. In some embodiments, the first predetermined temperature comprises about 85° C. In some embodiments, the second predetermined temperature comprises between about 43° C. to 45° C. In some embodiments, the second predetermined temperature comprises about 43° C. or less.

In some embodiments, mixing the biocide, the active ingredient, and the binder in the vessel comprises mixing at a first mixing speed; and mixing the biocide, the active ingredient, the binder, and the filler in the vessel comprises mixing at a second mixing speed, wherein the second mixing speed is higher than the first mixing speed. In some embodiments, the first mixing speed comprises about 5.7 revolutions per minute (RPM). the first mixing speed comprises between about 10 to 35 RPM. In some embodiments, the second mixing speed comprises about 69.6 RPM. In some embodiments, the second mixing speed comprises about 166 RPM.

In some embodiments, the method further includes stopping active temperature control of the vessel in response to reducing temperature to the second predetermined temperature; and mixing the biocide, the active ingredient, the binder, and the filler after stopping the active temperature control. In some embodiments, mixing the biocide, the active ingredient, and the binder in the vessel comprises mixing for about 12.5 minutes; and mixing the biocide, the active ingredient, the binder, and the filler in the vessel comprises mixing for about 60-90 minutes while reducing the temperature.

In some embodiments, the vessel comprises a high shear mixer. In some embodiments, the vessel comprises a plow baffle mixer. In some embodiments, the vessel comprises a Cowles blade mixer and a pitched turbine mixer.

### BRIEF DESCRIPTION OF THE DRAWINGS

The detailed description particularly refers to the following figures, in which:

FIG. 1 is a perspective view of an adhesive termite bait applicator system;

FIG. 2 is a perspective view of another adhesive termite bait applicator system;

FIG. 3 is a schematic diagram of a process for manufacturing the adhesive bait of FIGS. 1-2;

FIG. 4 is a simplified flow diagram of a process for manufacturing the adhesive bait of FIGS. 1-2;

FIG. 5 is a schematic diagram of a pest control system using the adhesive bait of FIGS. 4-5;

FIG. 6 is a simplified flow diagram of a process for using the pest control system of FIG. 5;

FIGS. 7-17 are charts illustrating experimental results that may be achieved using the adhesive bait of FIGS. 1-6; and

FIG. 18 is a schematic diagram of a process for manufacturing the adhesive bait of FIGS. 1-2.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

Referring now to FIG. 1, an adhesive bait applicator system 100 is configured to deliver an adhesive termite bait 102 to the site of an active, above-ground termite infestation. The adhesive bait 102 is an adhesive, extrudable, semi-solid bait material that is palatable to termites. The adhesive bait 102 includes an active ingredient that is a delayed action pesticide, such as noviflumuron or hexaflumuron. Such delayed action pesticides have delayed killing activity upon ingestion by or contact with termites, and typically do not operate to kill an individual pest until after the pest has returned to its colony.

The adhesive bait 102 is packaged in a disposable cartridge 104, which includes a nozzle 106 at one end and a seal 108 positioned at the other end, opposite the nozzle 106. The cartridge 104 is illustratively a standard-sized squeeze tube or other cartridge for a caulk gun 110 or other similar applicator tool. The caulk gun 110 includes a frame 112 configured to receive and support the cartridge 104, as well as a handle 114 and a trigger 116. The trigger 116 is operable to advance a plunger 118 against the seal 108. A ratcheting mechanism 120 allows the plunger 118 to advance against the seal 108 and resists backpressure exerted by the adhesive bait 102 against the seal 108. As the plunger 118 advances against the seal 108, the adhesive bait 102 is extruded out of the nozzle 106. In use, as described further below, an operator may use the applicator system 100 to dispense adhesive bait 102 onto the site of an active above-ground termite infestation, such as a structure, a tree, or other such site. The adhesive bait 102 adheres to the infestation site (which may be horizontal and/or vertical), and termites may then consume the adhesive bait 102.

In some embodiments, the adhesive bait 102 may be packaged in a disposable cartridge or other package that allows the adhesive bait 102 to be extruded without a caulk gun 110 or other external applicator tool. For example, in some embodiments the adhesive bait 102 may be packaged in a squeeze tube with a snip tip applicator. In those embodiments, the operator may cut the applicator tip and squeeze the side walls of the squeeze tube to dispense adhesive bait 102.

Although illustrated and described as a termite bait, it should be understood that in some embodiments the adhesive bait 102 may be used to eliminate other wood-destroying pests, such as any insect or other pest that destroys the structural integrity of wood by boring into wood or consuming wood. Examples include, without limitation, termites, carpenter ants, carpenter wasps and other wood boring or cellulose consuming organisms.

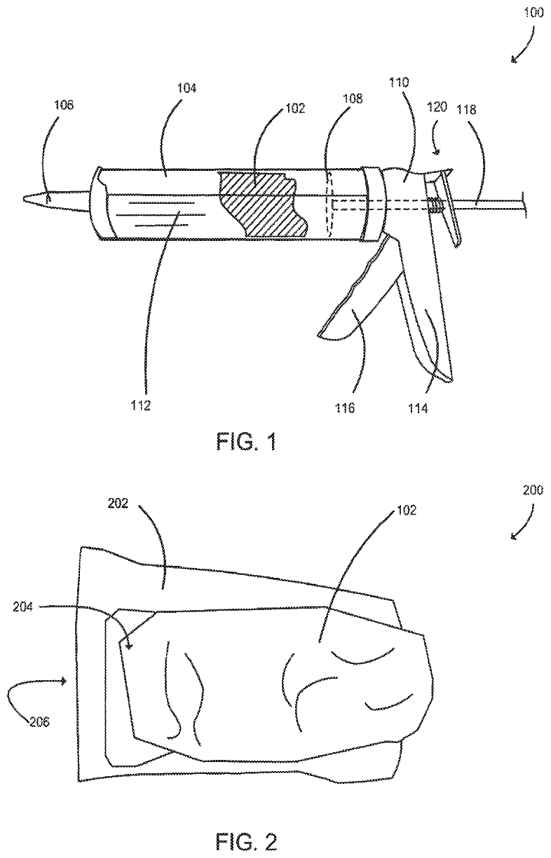

Referring now to FIG. 2, another embodiment of an adhesive bait applicator system 200 includes a flexible packet 202 that contains the adhesive bait 102. The flexible packet 202 is formed from a clear plastic material and is airtight to prevent drying and/or hardening of the adhesive bait 102. As shown, the flexible packet 202 includes a front side 204 and a back side 206. In use, as described further below, an operator may open or otherwise remove the front side 204 and/or the back side 206, which exposes the adhesive bait 102. The operator may then press the open side 204, 206 of the packet 202 to the site of an active above-ground termite infestation, which adheres the packet 202 to the site using the adhesive bait 102. Termites may then consume the adhesive bait 102 from within the packet 202.

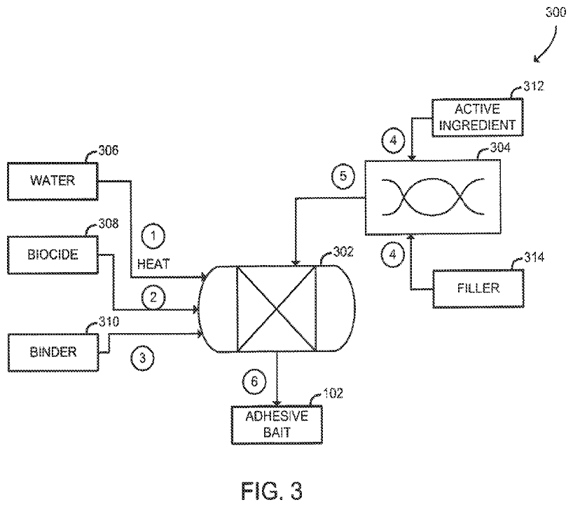

Referring now to FIG. 3, schematic diagram 300 illustrates manufacturing equipment and materials that may be used to perform a process for manufacturing the adhesive bait 102 of FIGS. 1-2. As shown, the manufacturing equipment includes a mixer 302 and a dry blender 304. The mixer 302 is illustratively a horizontal, baffled plow mixer with 4 L capacity available commercially from Processall. The mixer 302 provides mixing speed control as well as active temperature control, which is provided by the mixer 302 including a jacketed vessel that may be coupled to a heat exchanger. It should be understood that the mixer 302 may be embodied as any other mixer, agitator, or combination of equipment capable of performing homogenous mixing for thick materials with temperature and speed control as described herein. For example, in some embodiments, the mixer 302 may be embodied as a mixed blade agitator including a Cowles blade for radial mixing in combination with a pitched 45-degree turbine for axial mixing and a jacketed/temperature-controlled tank. As another example, in some embodiments the mixer 302 may be a pilot-scale mixer with 140 L capacity available commercially from Processall.

Similarly, the dry blender 304 may be embodied as any mixer capable of blending powders or other dry ingredients into a homogeneous mixture, such as a planetary mixer, a sigma kneader, a V-blender, a Forberg® batch mixer, or other mixer. In some embodiments, the dry blender 304 may be used with an air mill or other milling machine that reduces particle size of various ingredients to ensure homogeneous blending. Of course, in some embodiments, such as experimental batches, pilot batches, or other small batches, blending of dry ingredients may be performed by shaking, stirring, or otherwise mechanically blending ingredients without dedicated dry blending equipment.

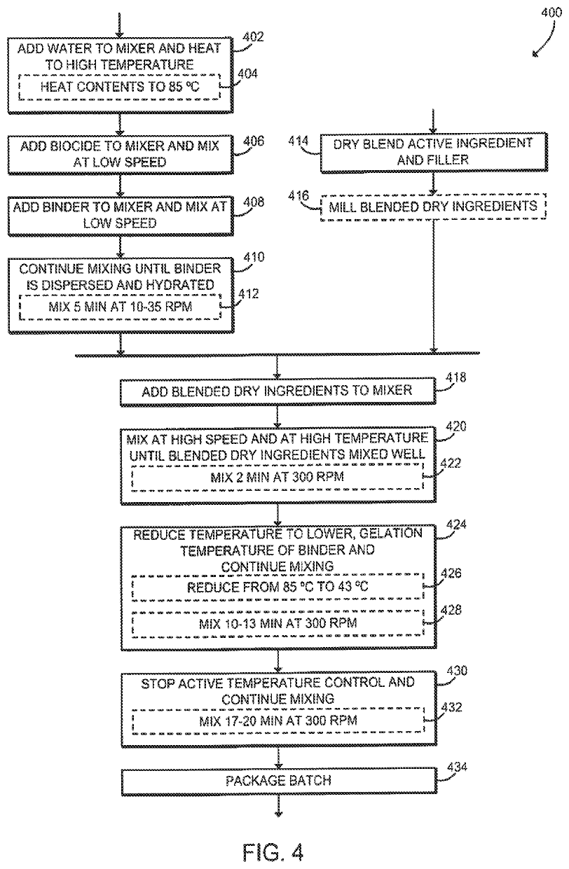

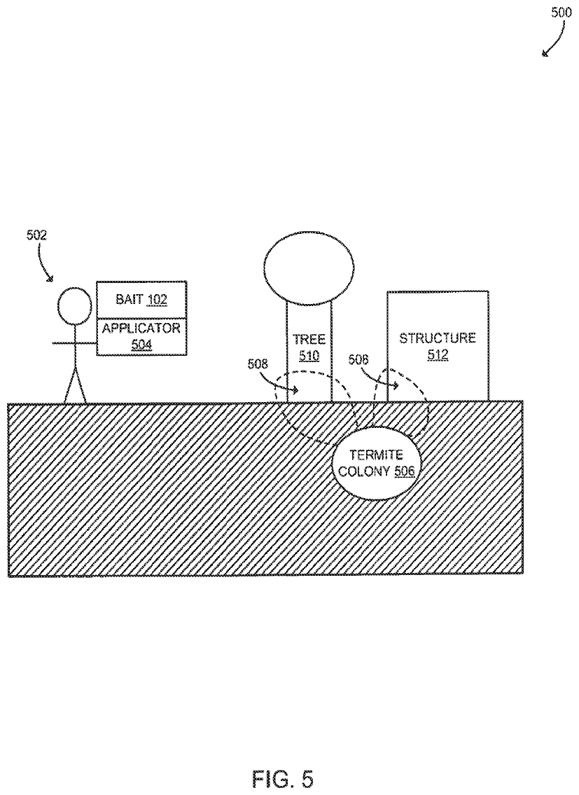

As shown in FIG. 3 and described in more detail with respect to the method shown in FIG. 4, the adhesive bait 102 is made by adding materials in a specific order and performing certain processing operations. In step 1, water 306 is added to the mixer 302 and heated, and then in step 2, a biocide 308 is added to the water 306. The biocide 308 is a broad spectrum preservative used to protect the adhesive bait 102 against spoilage from bacteria, yeasts, and fungi. The biocide 308 is illustratively Proxel® GXL, available commercially from Lonza, which is a 20% aqueous dipropylene glycol solution of 1,2-benzisothiazolin-3-one. It should be understood that in other embodiments, the adhesive bait 102 may use one or more different biocides 308, such as Koralone™ B-120 available commercially from DuPont, or a different biocide.

After heating and mixing the water 306 and the biocide 308, in step 3 a binder 310 is added to the mixer 302. The binder 310 is added to the mixer 302 at a high temperature, such that the binder 310 is insoluble in water. Illustratively, the binder 310 is Methocel™ A4M available commercially from DuPont, which is a medium molecular weight methylcellulose-based thickener. In other embodiments, the binder 310 may include one or more other cellulose esters or other modified cellulose. Adding the binder 310 at the high temperature helps ensure that the binder 310 is well dispersed in the mixture and all particles are thoroughly wetted, which improves consistency of the final product by improving gelation and uniformity of the mixture, because as cooling occurs the dispersed and wetted binder 310 starts to become water soluble and begins to hydrate, and thus viscosity increases uniformly across the mixture.

Independently from the mixer 302, in step 4 an active ingredient 312 and a filler 314 are blended together for better homogeneity using the dry blender 304. The active ingredient 312 is a delayed action pesticide suitable for above-ground use against termites, and more particularly is a chitin synthesis inhibitor. The active ingredient 312 is illustratively noviflumuron, although in other embodiments the active ingredient 312 may be hexaflumuron or another delayed action pesticide. The filler 314 is illustratively alpha cellulose, although in other embodiments may be another type of cellulose or other food material palatable to termites.

After blending, in step 5 the blended dry ingredients are added to the mixer 302. The dry ingredients are added at a high temperature so that they are homogeneously mixed with the mixture containing the binder 310, and so that the binder 310 is uniformly distributed around particles of the active ingredient 312 and the filler 314 before cooling and subsequent gelation of the binder 310 is initiated. In step 6, the temperature of the contents of the mixer 302 is reduced while mixing continues, and the binder 310 begins to gel. After cooling and mixing, the mixture forms the adhesive bait 102, which may be packaged into a cartridge 104 as shown in FIG. 1, a flexible pack 202 as shown in FIG. 2, a squeeze tube, or other package.

The adhesive bait 102 may include combinations of water 306, biocide 308, binder 310, active ingredient 312, and filler 314 in various proportions. In particular, one embodiment of the adhesive bait 102 may include from about 0.1% to about 0.2% by weight of active ingredient 312. That embodiment may include from about 1.8% to about 19% by weight of binder 310, about 0.2% by weight of biocide 308, and from about 11.8% to about 35% by weight of filler 314. The balance of the mixture is formed from water 306, from about 51.4% to about 84.5% by weight of water 306. In another embodiment, the adhesive bait 102 may include about 0.125% by weight of active ingredient 312, about 1.8% by weight of binder 310, about 0.2% by weight of biocide 308, about 21.675% by weight of filler 314, and about 76.2% by weight of water 306. In another embodiment, the adhesive bait 102 may include about 0.125% by weight of active ingredient 312, about 1.8% by weight of binder 310, about 0.1% by weight of biocide 308, about 21.675% by weight of filler 314, and about 76.3% by weight of water 306. Other potential formulations of the adhesive bait 102 are described below in connection with Examples 1-14 and 22.

After manufacturing, the adhesive bait 102 is a thick, viscous material that remains flowable through an applicator tool such as a caulk gun 110 and sticks to surfaces such as wood, cinder blocks, brick, siding, metals, and other building materials. The adhesive bait 102 also sticks to natural surfaces such as bark, wood, leaves, and other parts of trees or other woody plants. As described above, the adhesive bait 102 has a thick, paste-like consistency that tends to maintain its shape after being extruded or otherwise applied. In some embodiments, the adhesive bait 102 may have a viscosity above about 200 Pa·s. In some embodiments, the adhesive bait 102 has a viscosity in the range between about 200 Pa·s and 3000 Pa·s. In particular, the viscosity of the adhesive bait 102 may be high enough for the adhesive bait 102 to adhere to surfaces, to maintain shape after being extruded, and to avoid dripping excessively from the applicator tool, while being low enough to flow through the applicator tool acceptably while being applied. In another embodiment, the adhesive bait 102 has a viscosity from about 289.4 Pa·s to about 447.6 Pa·s. In yet another embodiment, the adhesive bait 102 has a viscosity of about 447.6 Pa·s. It has been found that adhesive bait 102 with a higher viscosity, for example about 8000 Pa·s, is difficult to flow through an applicator tool and thus such high viscosity is not recommended. When exposed to air, the adhesive bait 102 dries and hardens, and when covered with plastic or another nonpermeable cover, the adhesive bait 102 remains soft and viscous. When applied outdoors, the adhesive bait 102 is environmentally resistant and rainfast. For example, in outdoor tests, adhesive bait 102 has been adhered to live tree trunks. In follow up inspections, it was determined that after one month, the adhesive bait 102 (that was not consumed by termites) remained attached to the tree trunk. The adhesive bait 102 may maintain its material properties when stored for a certain amount of time in certain temperature ranges. For example, in at least one embodiment, the adhesive bait 102 may remain stable when stored at 40° C. for eight weeks, which is equivalent to storage at ambient temperature for two years.

Referring now to FIG. 4, in use, a method 400 may be performed for manufacturing the adhesive bait 102. The method 400 starts in blocks 402, 414, which may be performed simultaneously, at different times, or otherwise independently. In block 402, an amount of water 306 is added to the mixer 302 and heated to a predetermined high temperature. Illustratively, the amount of water 306 may be equal to 76.2% by weight of the final adhesive bait 102. For example, for a 2.5 kg batch, 1.905 kg of water 306 may be added to the mixer 302. The predetermined high temperature is selected such that the binder 310 is insoluble in water. In some embodiments, in block 404 the water 306 is heated to about 85° C. In other embodiments, the water 306 may be heated to a different high temperature, such as 90° C. The predetermined high temperature may depend on batch size. For example, for a larger scale batch a high temperature in the range 78-82° C. may be feasibly achievable.

In block 406, the biocide 308 is added to the mixer 302 and the resulting mixture is mixed at low speed. The selected mixing speed may depend on the particular mixer 302 in use. For example, the mixer 302 may mix at 10-35 RPM (corresponding to a tip speed of about 0.08-0.29 m/s for the illustrative mixer) or another relatively low speed in order to prevent excessive foaming of the biocide 308. As another example, a larger 140 L mixer may at about 5.7 RPM. In the illustrative embodiment, the biocide 308 is Proxel GXL, and is added in an amount equal to 0.2% by weight of the final adhesive bait 102. For example, for a 2.5 kg batch, 5 g of biocide 308 may be added. Mixing continues until the biocide 308 is well dispersed in the water 306. Adding the illustrative biocide 308, Proxel GXL, to the mixture increases pH of the mixture to above 9.0. This pH is within an acceptable range for Methocel A4M, which is the binder 310 used in the illustrative embodiment.

In block 408, the binder 310 is added to the mixer 302 and the resulting mixture is mixed at low speed. The binder 310 is added to the mixer 302 when the temperature of the water 306 and biocide 308 mixture is above 82° C. or otherwise at the predetermined high temperature described above (e.g., 85° C.). In the illustrative embodiment, the binder 310 is Methocel A4M, and is added in an amount equal to 1.8% by weight of the final adhesive bait 102. For example, for a 2.5 kg batch, 45 g of binder 310 may be added. In block 410, the mixer 302 continues mixing the mixture of water 306, biocide 308, and binder 310 at low speed until the binder 310 is dispersed and hydrated (wetted). As described above, the mixture remains at the predefined, high temperature level (e.g., 85° C.) so that the binder 310 is insoluble in the water 306. In some embodiments, in block 412 the mixture may be mixed for five minutes at 10-35 RPM. Such combination of mixing speed and time may ensure that the binder 310 is well dispersed and wetted, and may reduce foaming and/or bubbling. After mixing is complete, the method 400 advances to block 418, described below.

As described above, the method 400 also begins with block 414, in which the active ingredient 312 and the filler 314 are dry blended with the dry blender 304. In the illustrative embodiment, the active ingredient 312 is noviflumuron, and the filler 314 is alpha cellulose. The active ingredient 312 is added in an amount equal to 0.125% by weight of the final adhesive bait 102. For example, for a 2.5 kg batch, 3.14 g of noviflumuron may be added. The filler 314 is added in an amount equal to 21.675% by weight of the final adhesive bait 102. For example, for a 2.5 kg batch, 0.542 kg of alpha cellulose may be added. The active ingredient 312 and the filler 314 are dry blended until homogeneous. Dry blending the active ingredient 312 and the filler 314 may improve homogeneity of the active ingredient 312 in the final product. For example, noviflumuron typically does not dissolve or disperse well in water. Blending the noviflumuron with cellulose, which interacts more easily with water than noviflumuron, may allow the noviflumuron to be more evenly distributed when exposed to water, for example due to surface activity from static attraction between noviflumuron and cellulose powders. In some embodiments, in block 416 the blended active ingredient 312 and filler 314 may be milled. Milling reduces the size of certain particles in the dry blend until all particles are of uniform size, which also may increase homogeneity of the resulting mixture. After milling, the dry ingredients may be re-blended. After blending and/or milling is completed, the method 400 proceeds to block 418.

In block 418, the blended active ingredient 312 and filler 314 are added to the mixer 302. In block 420, the resulting mixture is mixed at high speed and high temperature until the active ingredient 312 and the filler 314 are well-mixed throughout the mixture. As described above, at the high temperature (e.g., about 85° C.), the binder 310 is insoluble in water. Thus, mixing at high speed and high temperature allows the active ingredient 312 and the filler 314 to be uniformly mixed with the mixture containing the water 306, the biocide 308, and the binder 310. In some embodiments, a wetter may be added to the mixture in order to assist hydrating the active ingredient 312 (e.g., noviflumuron). The wetter may be embodied as, for example, Morwet® D-425 available commercially from Nouryon, or another appropriate surfactant. In such embodiments, when a wetter is added to the mixture, dry blending of the active ingredient 312 and the filler 314 may not be necessary. In some embodiments, in block 422, the mixture may be mixed for two minutes at 300 RPM (corresponding to a tip speed of about 2.45 m/s for the illustrative mixer). This combination of mixing speed and time may ensure that the dry ingredients are well-mixed throughout the mixture. After mixing at high temperature, the mass of the dry blend is mixed well, and the mixture may have a broken, wet-cotton-like appearance.

In block 424, the temperature of the mixture is reduced to a lower, gelation temperature of the binder 310, and mixing continues at high speed. Temperature may be reduced, for example, by circulating chilled water through a jacket of the mixer 302 or through other active temperature control. As described above, at higher temperatures the binder 310 (e.g., Methocel A4M or other methylcellulose) is insoluble in water. At the lower gelation temperature, the binder 310 is soluble in water and starts to gel and otherwise thicken and become viscous. As the temperature reduces, the broken/fragmented, wet-cotton-like texture of the mixture starts to become cohesive and continuous, like a very thick fluid. In some embodiments, in block 426, the temperature may be reduced below 45° C., for example from 85° C. to 43° C. In some embodiments, in block 428 the mixture may be mixed for 10-13 minutes at 300 RPM. After mixing for the 10-13 minutes, the temperature of the mixture may reach the lower, gelation temperature (e.g., 43° C. or lower).

In block 430, active temperature control of the mixer 302 is stopped, and the mixture continues mixing at high speed. After stopping active temperature control, the temperature of the mixture may reduce or otherwise drift toward ambient, and the mixture continues to thicken. Because the mixture has reached a lower, gelation temperature, further active reductions in temperature are not necessary to thicken the mixture. Thus, stopping active temperature control after the mixture reaches the lower, gelation temperature (e.g., 43° C.) may save energy and improve efficiency of the manufacturing process. In some embodiments, in block 432, the mixture is mixed for 17-20 minutes at 300 RPM. This combination of mixing speed and time may ensure that the mixture fully gels and that all ingredients remain well distributed. After mixing is complete, the mixture forms the adhesive bait 102, and has a smooth, homogeneous, paste-like consistency.

In block 434, the batch of adhesive bait 102 is packaged. The adhesive bait 102 may be packaged, for example, in a cartridge 104 as shown in FIG. 1, in a flexible packet 202 as shown in FIG. 2, in a squeeze tube, or in another suitable container. After packaging, the method 400 is completed, and the method 400 may be restarted for additional batches. Additionally, although illustrated as a batch method, it should be understood that the operations of the method 400 may be performed continuously or otherwise performed. Additionally, in some embodiments, additional processing steps and equipment may be used to manufacture the adhesive bait 102. For example, in some embodiments the bait 102 may be subjected to vacuum in order to release air bubbles, which may improve final texture of the adhesive bait 102.

Referring now to FIG. 5, a schematic diagram 500 illustrates use of the adhesive bait 102. As shown, an operator 502 carries a hand-held applicator 504, which may be embodied as a caulk gun 110 as shown in FIG. 1, a flexible placket 202 as shown in FIG. 2, or another applicator tool for use with the adhesive bait 102.

As shown in FIG. 5, a subterranean termite colony 506 is the source of multiple active infestations 508. The termite colony 506 may include Formosan termites (Coptotermes formosanus), Asian termites (C. gestroi), native subterranean termites (e.g., Reticulitermes flavipes, R. virginicus, R. hesperus, or other Reticulitermes species), or another species of termite (e.g., Heterotermes aureus), or other wood-destroying pests. As shown, the termite colony 506 is located underground, but foraging termites travel through the ground and above ground to find food sources. Food sources may include trees 510, structures 512, or other above-ground objects that are palatable to termites.

Trees 510 may include native trees, ornamental trees, crop trees, or other trees that may include active infestations 508 of termites. In particular, the termites may consume one or more parts of the tree 510, which may weaken and ultimately kill the tree 510. For example, certain termite species (e.g., C. formosanus) may consume non-living heartwood within the tree, which weakens the tree and makes the tree more vulnerable to hurricanes, storm damage, or other damage. As another example, certain termite species (e.g., C. gestroi) may girdle tissue between the bark and the heartwood that provides vascular transport to the tree, which may kill the tree. Particular examples of tree species that may include active termite infestations 508 may include live oak, ash, sweetgum, pecan, oil palm trees, and other tree species. Trees 510 may be natural, wild trees 510 or may be cultivated in plantations, yards, parks, or other locations.

Similarly, structures 512 may include houses, multifamily residences, barns, outbuildings, fences, walls, commercial buildings, public buildings, and other structures made from wood or otherwise palatable to termites. As shown in FIG. 5, a single termite colony 506 may support multiple active infestations 508 of trees 510 and/or structures 512. Additionally or alternatively, a single tree 510, structure 512 and/or other above ground infestation 508 may be caused by multiple termite colonies 506.

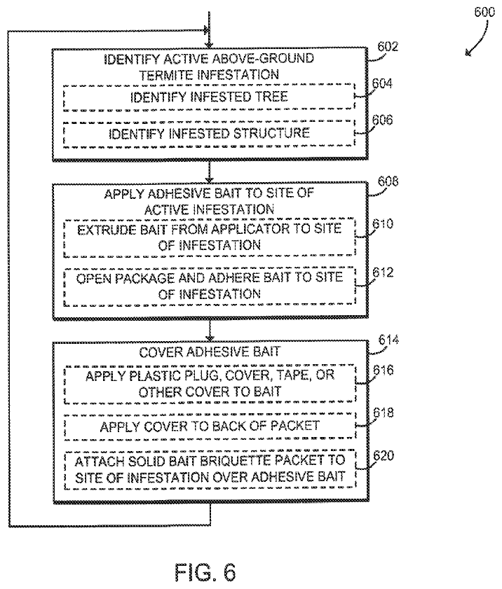

Referring now to FIG. 6, in use, the operator 502 performs a method 600 for termite control. The method 600 begins in block 602, in which the operator 502 identifies an active above-ground termite infestation 508. The operator 502 may, for example, identify live termites or evidence of recent termite activity, such as galleries, mud tubes, or other indications of an active infestation. The operator 502 may use visual inspection, an above-ground monitoring station, an in-ground monitoring station with electronic sensing protection (ESP), imaging with an endoscope, or other technique to identify active infestations 508. In some embodiments, in block 604, the operator 502 may identify an infested tree 510. As described above, the tree 510 may be a crop tree (e.g., an oil palm tree), a decorative tree, a native tree, or other woody plant. In some embodiments, in block 606, the operator 502 may identify an infested structure 512, such as a house or outbuilding. In some embodiments, the identified infested tree and/or structure may be included among many trees and/or structures located in area with an active termite infestation 508.

In block 608, the operator 502 uses the applicator 504 to apply adhesive bait 102 to the site of the active infestation 508. In some embodiments, in block 610 the operator 102 may extrude the adhesive bait 102 from the applicator 504 (e.g., from a caulk gun 110) to the site of the active infestation 508. For example, the operator may extrude the adhesive bait 102 into galleries, shelter tubes, or other tunnels formed by the termites within the tree 510 and/or structure 512. The operator may drill a hole into the tree 510 and/or structure 512 in order to access the gallery, and then extrude the adhesive bait 102 into the hole. As another example, the operator 502 may break mud tubes and then extrude adhesive bait 102 onto the broken mud tubes. As another example, the operator 502 may apply the adhesive bait 102 to a hole or other opening formed in the tree 510 and/or structure 512. As another example, the operator 502 may apply the adhesive bait 102 directly to the surface of the tree 510 and/or structure 512. The adhesive bait 102 adheres to the site of the active infestation 508 and remains in place without substantially slouching or running off the site.

In some embodiments, in block 612 the operator 502 may open a package of adhesive bait 102 (e.g., a flexible packet 202) and adhere the adhesive bait 102 to the site of the active infestation 508. For example, the operator 502 may cut, peel, or otherwise open the front side 204 or back side 206 of a flexible packet 202 to expose the adhesive bait 102. The operator 102 presses the adhesive bait 102 onto the site of the active infestation 508 (e.g., onto a surface of a tree 510 and/or structure 512), and the adhesive bait 102 adheres to the site. The flexible packet 202 is held against the site by the adhesive bait 102, and serves to cover and protect the adhesive bait from the environment.

In block 614, the operator 502 may cover the adhesive bait 102. Covering the adhesive bait 102 protects the adhesive bait 102 from the environment, and may prevent persons and/or animals from contacting or otherwise interacting with the adhesive bait 102. Additionally, covering the adhesive bait 102 may slow or prevent hardening of the adhesive bait 102, which may improve palatability for termites. In some embodiments, in block 616, the operator 502 may apply a plastic plug, plastic cover, tape, or other material to cover the adhesive bait 102. For example, when the operator 502 has drilled a hole in a tree 510 and/or structure 512 to access the termite gallery, the operator 502 may cover the hole with a plastic plug. As another example, when the operator 502 has adhered adhesive bait 102 to a surface of the tree 510 and/or structure 512, the operator 502 may cover the entire adhesive bait 102 with plastic sheeting. The cover may adhere to the adhesive bait 102 or may be held with other means. In some embodiments, in block 618 the operator 502 may apply a cover to the back side 206 of a packet 202 that is adhered to the site of the active infestation 508. For example, the flexible packet 202 may be formed from clear plastic, and the operator 502 may cover the packet 202 with an opaque plastic cover.

In some embodiments, in block 620 the operator 502 may attach a solid bait briquette packet to the site of the active infestation 508 over the adhesive bait 102. In those embodiments, the operator 502 may not cover the adhesive bait 102 prior to attaching the briquette packet. The briquette packet may be formed from clear plastic similar to the flexible packet 202, but may be filled with a solid termite bait in briquette form or other solid matrix termite bait. In some embodiments, the briquette packet may be a Recruit® AG FLEXPACK™ available commercially from Corteva Agriscience™. When attached, the solid bait within the briquette packet is in contact with the adhesive bait 102, allowing termites feeding on the adhesive bait 102 to reach the contents of the briquette packet.

After applying the adhesive bait 102 to the site of the active infestation 508, foraging termites will consume the adhesive bait 102, including the delayed action active ingredient (e.g., noviflumuron or hexaflumuron). The foraging termites return to the subterranean colony 506, at which point the delayed action active ingredient begins to kill individual pests. As the foraging termites continue to consume the adhesive bait 102, the population of the termite colony 506 is reduced, until the colony 506 and/or the active infestation 508 is eliminated. As described further below in connection with multiple Examples, the adhesive bait 102 is effective to eliminate above-ground termite infestations in trees 510 and structures 512 for multiple termite species. Additionally or alternatively, in some embodiments, the adhesive bait 102 may provide wide-area control for infested tree areas (e.g., tree crop plantations or other areas). After applying and covering the adhesive bait 102, the method 600 returns to block 602, in which the operator may continue to monitor or otherwise identify active infestations 508 and perform termite control operations.

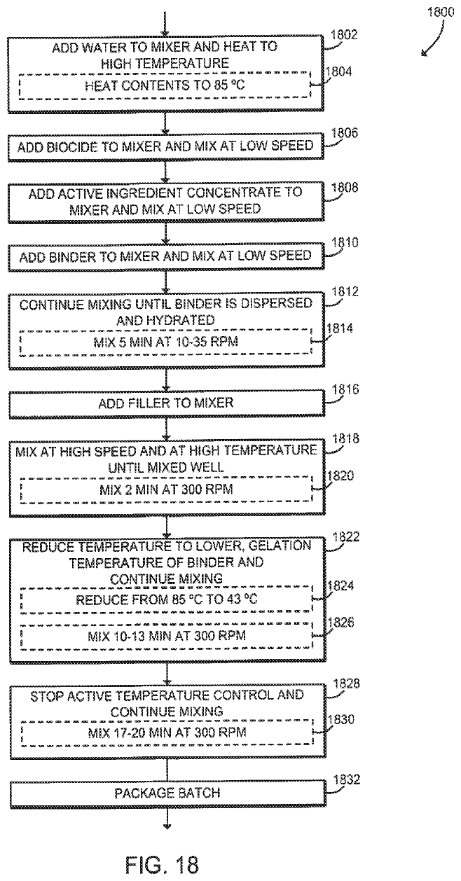

Referring now to FIG. 18, in use, another method 1800 may be performed for manufacturing the adhesive bait 102. The method 1800 starts in block 1802, in which an amount of water 306 is added to the mixer 302 and heated to a predetermined high temperature. Illustratively, the amount of water 306 may be equal to 76.2% by weight of the final adhesive bait 102. For example, for a 2.5 kg batch, 1.905 kg of water 306 may be added to the mixer 302. The predetermined high temperature is selected such that the binder 310 is insoluble in water. In some embodiments, in block 1804 the water 306 is heated to about 85° C. In other embodiments, the water 306 may be heated to a different high temperature, such as 90° C.

In block 1806, the biocide 308 is added to the mixer 302 and the resulting mixture is mixed at low speed. For example, the mixer 302 may mix at 10-35 RPM (corresponding to a tip speed of about 0.08-0.29 m/s for the illustrative mixer) or another relatively low speed in order to prevent excessive foaming of the biocide 308. In the illustrative embodiment, the biocide 308 is Proxel GXL, and is added in an amount equal to 0.2% by weight of the final adhesive bait 102. For example, for a 2.5 kg batch, 5 g of biocide 308 may be added. In other embodiments, the biocide 308 may be added in a reduced amount, for example an amount equal to 0.1% by weight of the final adhesive bait 102 (e.g., 2.5 g of biocide 308 for a 2.5 kg batch). Mixing continues until the biocide 308 is well dispersed in the water 306. Adding the illustrative biocide 308, Proxel GXL, to the mixture increases pH of the mixture to above 9.0. This pH is within an acceptable range for Methocel A4M, which is the binder 310 used in the illustrative embodiment.

In block 1808, an active ingredient 312 concentrate is added to the mixer 302 and the resulting mixture is mixed at low speed. In the illustrative embodiment, the active ingredient 312 concentrate is a noviflumuron liquid suspension. Illustratively, the liquid suspension is noviflumuron multi-use concentrate (MUC), which is a liquid suspension of 50% by weight noviflumuron. The active ingredient 312 is added in an amount equal to 0.125% by weight of the final adhesive bait 102. For example, for a 2.5 kg batch, 6.28 g of noviflumuron 50% concentrate may be added, which corresponds to 3.14 g of active ingredient 312. The noviflumuron MUC mixes into solution well with minimal bubbling.

In block 1810, the binder 310 is added to the mixer 302 and the resulting mixture is mixed at low speed. The binder 310 is added to the mixer 302 when the temperature of the water 306, biocide 308, and active ingredient 312 mixture is above 82° C. or otherwise at the predetermined high temperature described above (e.g., 85° C.). In the illustrative embodiment, the binder 310 is Methocel A4M, and is added in an amount equal to 1.8% by weight of the final adhesive bait 102. For example, for a 2.5 kg batch, 45 g of binder 310 may be added. In block 1812, the mixer 302 continues mixing the mixture of water 306, biocide 308, and binder 310 at low speed until the binder 310 is dispersed and hydrated (wetted). As described above, the mixture remains at the predefined, high temperature level (e.g., 85° C.) so that the binder 310 is insoluble in the water 306. In some embodiments, in block 1814 the mixture may be mixed for five minutes at 10-35 RPM. Such combination of mixing speed and time may ensure that the binder 310 is well dispersed and wetted.

In block 1816, the filler 314 is added to the mixer 302. In the illustrative embodiment, the filler 314 is alpha cellulose. The filler 314 is added in an amount equal to 21.675% by weight of the final adhesive bait 102. For example, for a 2.5 kg batch, 0.542 kg of alpha cellulose may be added. The filler 314 may be added in gradually and/or in stages to the mixer while mixing continues.

In block 1818, the resulting mixture is mixed at high speed and high temperature until the active ingredient 312 and the filler 314 are well-mixed throughout the mixture. As described above, at the high temperature (e.g., about 85° C.), the binder 310 is insoluble in water. Thus, mixing at high speed and high temperature allows the active ingredient 312 and the filler 314 to be uniformly mixed with the mixture containing the water 306, the biocide 308, and the binder 310. In some embodiments, in block 1820, the mixture may be mixed for two minutes at 300 RPM (corresponding to a tip speed of about 2.45 m/s for the illustrative mixer). This combination of mixing speed and time may ensure that the ingredients are well-mixed throughout the mixture. After mixing at high temperature, the mass of the dry blend is mixed well, and the mixture may have a broken, wet-cotton-like appearance.

In block 1822, the temperature of the mixture is reduced to a lower, gelation temperature of the binder 310, and mixing continues at high speed. Temperature may be reduced, for example, by circulating chilled water through a jacket of the mixer 302 or through other active temperature control. As described above, at higher temperatures the binder 310 (e.g., Methocel A4M or other methylcellulose) is insoluble in water. At the lower gelation temperature, the binder 310 is soluble in water and starts to gel and otherwise thicken and become viscous. As the temperature reduces, the broken/fragmented, wet-cotton-like texture of the mixture starts to become cohesive and continuous, like a very thick fluid. In some embodiments, in block 1824, the temperature may be reduced below 45° C., for example from 85° C. to 43° C. In some embodiments, in block 1826 the mixture may be mixed for 10-13 minutes at 300 RPM. After mixing for the 10-13 minutes, the temperature of the mixture may reach the lower, gelation temperature (e.g., 43° C.).

In block 1828, active temperature control of the mixer 302 is stopped, and the mixture continues mixing at high speed. After stopping active temperature control, the temperature of the mixture may reduce or otherwise drift toward ambient, and the mixture continues to thicken. Because the mixture has reached a lower, gelation temperature, further active reductions in temperature are not necessary to thicken the mixture. Thus, stopping active temperature control after the mixture reaches the lower, gelation temperature (e.g., 43° C.) may save energy and improve efficiency of the manufacturing process. Additionally or alternatively, in some embodiments, active cooling may continue to even lower temperatures (e.g., 35° C.), which may improve process performance for larger batches. In some embodiments, in block 1830, the mixture is mixed for 17-20 minutes at 300 RPM. This combination of mixing speed and time may ensure that the mixture fully gels and that all ingredients remain well distributed. After mixing is complete, the mixture forms the adhesive bait 102, and has a smooth, homogeneous, paste-like consistency.

In block 1832, the batch of adhesive bait 102 is packaged. The adhesive bait 102 may be packaged, for example, in a cartridge 104 as shown in FIG. 1, in a flexible packet 202 as shown in FIG. 2, in a squeeze tube, or in another suitable container. After packaging, the method 1800 is completed, and the method 1800 may be restarted for additional batches. Additionally, although illustrated as a batch method, it should be understood that the operations of the method 1800 may be performed continuously or otherwise performed. Additionally, in some embodiments, additional processing steps and equipment may be used to manufacture the adhesive bait 102. For example, in some embodiments the bait 102 may be subjected to vacuum in order to release air bubbles, which may improve final texture of the adhesive bait 102.

The subject matter of the present application will be further described with reference to the following specific Examples. It will be understood that these Examples are intended to be illustrative and not restrictive in nature.

### EXAMPLES

### Example 1

Experimental batches of adhesive bait were manufactured using different binders as well as different compositions of binder, cellulose, biocide, and solvent (water). Sizes varied for batches from about 100 g to 4 kg to about 7 kg. Binders and bait composition are shown in Table 1, below. Composition of binder, cellulose, water, and biocide are expressed in percent by weight. Proxel GXL was used for each batch that included a biocide. The various binders are listed used have different chemistries and are listed under their commercially available names. Walocel™ CRT 70PA and Walocel CRT 1000PA are carboxymethyl cellulose available commercially from DuPont. As described above, Methocel and Methocel A4M are methylcellulose (a cellulose ester). Cellosize™ and Cellosize QP-100MH EU are hydroxyethyl cellulose (a cellulose ester) available commercially from The Dow Chemical Company (“Dow”). Rovace™ 86 is vinyl acrylic polymer available commercially from Dow. Selvol™ 205 is polyvinyl alcohol available commercially from Sekisui Specialty Chemicals.

TABLE 1
Experimental batches of adhesive bait.

| Batch No. | Binder | Binder % | Cellulose % | Water % | Biocide % |
|---|---|---|---|---|---|
| 005A | Walocel CRT 70PA | 15.50% | 0.00% | 84.50% | |
| 005B | Walocel CRT 70PA | 7.10% | 12.30% | 80.60% | |
| 005C | Methocel | 19.00% | 0.00% | 80.95% | |
| 005D | Methocel | 12.30% | 11.80% | 75.92% | |
| 005E | Cellosize | 18.10% | 0.00% | 81.92% | |
| 005F | Cellosize | 14.20% | 14.90% | 70.89% | |
| 005G | Walocel CRT 70PA | 5% | 20% | 75% | |
| 005H | Methocel | 5% | 20% | 75% | |
| 005I | Cellosize | 5% | 20% | 75% | |
| 022A | Walocel CPT 70PA | 6.2% | 23.1% | 70.62% | 0.15% |
| 022B | Methocel F50 | 6.2% | 23.1% | 70.55% | 0.15% |
| 022C | Cellosize HEC EP-09E | 6.2% | 23.1% | 70.55% | 0.15% |
| 022D | Walocel CPT 1000PA | 6.2% | 23.1% | 70.55% | 0.15% |
| 022E | Walocel CPT 70PA | 6.2% | 23.1% | 70.70% | 0% |
| 026-1 | Rovace 86 | 19% | 23% | 58% | |
| 026-2 | Rovace 86 + Walocel | 19% | 21% | 61% | 0% |
| | CRT 1000PA (13/6 ratio) | | | | |
| 029 | Selvol 205 | 13.7% | 35.0% | 51.4% | 0.0% |
| 031A | Methocel A4M | 6.2% | 23.1% | 70.6% | 0.2% |
| 031B | Cellosize QP-100MH EU | 6.2% | 23.1% | 70.6% | 0.2% |
| 002 | Methocel A4M | 1.8% | 21.6% | 76.2% | 0.2% |
| Current | Methocel A4M | 1.8% | 21.6% | 76.3% | 0.2% |

Batches were prepared using a planetary stand mixer with a high shear Cowles disperser blade. Batch numbers 005A through 005I created material suitable for use as adhesive bait. Batches 005A through 005F were tested for termite palatability and resulted in limited feeding. Batches 005G through 005I, with increased cellulose content, resulted in improved termite feeding.

Batch numbers 022A through 022E created material suitable for use as adhesive bait. For batch number 022A, water was added to a tri-pour vessel attached to a mixing stand with high shear Cowles disperser blade. The agitator was turned on slowly at first. Walocel CPT 70PA was added, and the mixer was agitated aggressively to make a translucent solution. BH100 cellulose powder was added, and then Proxel GXL was added. For batch number 022B, water was added to a stainless steel beaker attached to the mixing stand with high shear Cowles disperser blade. The agitator was turned on slowly at first. Methocel F50 was added, and the mixer was agitated aggressively to make a translucent solution. BH100 cellulose powder was added, and then Proxel GXL was added. For batch number 022C, water was added to a stainless steel beaker attached to the mixing stand with high shear Cowles disperser blade. The agitator was turned on slowly at first. Cellosize HEC EP-09E was added, and the mixer was agitated aggressively to make a translucent solution. BH100 cellulose powder was added, and then Proxel GXL was added. Batch number 022E, prepared without biocide, was found degraded due to mold.

Batch number 026-1 failed to create material suitable for use as adhesive bait. For batch number 026-1, BH100 cellulose powder was added to the high shear blender. Rovace 86 binder was added dropwise to the blender to distribute. Water was added until the material reached a thick, caulk-like consistency. The resulting material was not suitable for use as adhesive bait. The material was not tacky enough, and did not stick to materials. Additionally the material was difficult to push out of a syringe. Instead of flowing out of the syringe, water was squeezed out of the material.

Batch number 026-2 created material suitable for use as adhesive bait. For batch number 026-2, Walocel CRT 1000 PA binder was added to the high shear blender. Water was slowly added while mixing to prepare a viscous gel phase. Rovace 86 was added while mixing. BH100 cellulose powder was added and the material was mixed with the high shear blender. Proxel GXL was added. The resulting material was tacky and flowable. The material was pushable out of a syringe. A bead of material was made and the material hardened overnight. Thus, the formulation of batch number 026-2 gave binding and formed a hard material.

Samples from batches 022A to 022D and batch 026-2 were used for a weatherability and waterfastness study. A bead of each sample was extruded onto a wood substrate. A sample from each batch was allowed to dry, and another sample was tested when still wet. Samples were placed outdoors over an 18 hour period including a rainstorm with 2-3 inches of rain. Samples 022B and 022C were most robust of the tested samples. Samples 022A and 022D were poor performing and tended to wash away during the rain. Sample 026-2 performed acceptably when allowed to dry before being exposed to rain; sample 026-2 washed away when exposed to rain while still wet.

Batch number 029 failed to create material suitable for use as adhesive bait. A mixture of Selvol 205 and water was prepared by dissolving the Selvol in water. BH100 alpha cellulose was added to the mixture. The material reached a thick, caulk-like consistency. The material was applied to a piece of wood. The material did not have good tack properties, and did not adhere to the wood.

Batch number 031A created a material suitable for use as adhesive bait. The tank for the high shear mixer was placed in an ice bath. Chilled water was added to the tank, and the agitator was turned on slowly, initially. Methocel A4M was added to the mixer, and was agitated aggressively to make a translucent solution. BH100 alpha cellulose was added to the mixer, and then Proxel GXL was added to the mixer.

Batch number 031B created a material suitable for use as adhesive bait. Water was added to mixer, and the agitator was turned on slowly, initially. Cellosize QP-100MH EU was added to the mixer, and was agitated aggressively to make a translucent solution. BH100 alpha cellulose was added to the mixer, and then Proxel GXL was added to the mixer.

Batch number 002 created adhesive bait. 1500 g of BH100 alpha cellulose was added to 3750 g of water to form component 1. 1537.5 g of cold water, 127.5 g of Methocel A4M, 15 g of Proxel GXL, and 8.25 g of noviflumuron technical powder were combined to form component 2. Component 1 was added to Component 2 to form adhesive bait.

### Example 2

Experimental batches of adhesive bait 102 were manufactured using a metal beaker with a Cowles blade sawtooth mixer and a planetary stand mixer. The planetary stand mixer is available commercially from Hobart. The metal beaker was placed in an ice water bath. 1.108 kg water and 0.011 kg Proxel GXL were combined in the metal beaker and overhead stirring was initiated with the sawtooth blade. 0.092 kg Methocel A4M was added to the metal beaker in batches, and the mixture was mixed until no clumps remained. 0.006 kg noviflumuron was then added to the metal beaker. In a separate operation, 1.081 kg alpha cellulose was added to the bowl of the planetary stand mixer. A small portion of 2.703 kg water was added to the bowl, and stirring of the planetary mixer was initiated. The remaining water was added in batches, and the mixture was stirred until an even consistency was reached. The mixture including noviflumuron and Methocel A4M was then added to the bowl in 4-5 batches. The mixture was stirred for about five minutes between additions, and the bowl sides and mixer blade were scraped between additions. The mixture was stirred for about 10 minutes after the final addition. The process performed in Example 2 resulted in about 15% variability in the concentration of active ingredient (noviflumuron) between samples picked from different parts of the same batch. Viscosity of an experimental batch made with the process described in Example 2 was measured as 311.1 Pa. s.

### Example 3

In a revision of the process described above in connection with Example 2, additional experimental batches of adhesive bait 102 were manufactured using a metal beaker with a Cowles blade sawtooth mixer and a planetary stand mixer. The planetary stand mixer is available commercially from Hobart. Initially, 0.092 kg of Methocel A4M and 0.010 kg of noviflumuron were placed in a plastic bag and shaken by hand to combine. The metal beaker was placed in an ice water bath. 1.108 kg of water and 0.011 kg of Proxel GXL were combined in the metal beaker and overhead stirring was initiated with the sawtooth blade. The combined noviflumuron and Methocel A4M powder was added to the metal beaker in batches, and the mixture was mixed until no clumps remained. In a separate operation, 1.081 kg of alpha cellulose was added to the bowl of the planetary stand mixer. A small portion of 2.703 kg of water was added to the bowl, and stirring of the planetary mixer was initiated. The remaining water was added in batches, and the mixture was stirred until an even consistency was reached. The mixture including noviflumuron and Methocel A4M was then added to the bowl in 4-5 batches. The mixture was stirred for about five minutes between additions, and the bowl sides and mixer blade were scraped between additions. The mixture was stirred for about 10 minutes after the final addition.

The process performed in Example 3 resulted in about 25% variability in the concentration of active ingredient (noviflumuron) between samples picked from different parts of the same batch. Results of an analysis of an experimental batch are shown in Table 2, below. Viscosity of an experimental batch mixture was measured as 446.7 Pa·s.

TABLE 2
Analysis of Example 3 product.

| | Wt. % | Average |
|---|---|---|
| Sample | Noviflumuron | wt. % |
| Sample A replicate 1 | 0.24 | 0.24 |
| Sample A replicate 2 | 0.25 | |
| Sample B replicate 1 | 0.16 | 0.18 |
| Sample B replicate 2 | 0.19 | |
| Sample C replicate 1 | 0.19 | 0.19 |
| Sample C replicate 2 | 0.20 | |

### Example 4

An experimental blank batch of adhesive bait 102 was manufactured using a 4 L mixer available commercially from Processall. The mixer provided plow baffle action mixer with speed control and temperature control. The batch had an expected amount of 1.5 kg and targeted 0.2% active ingredient (noviflumuron) loading by weight. The jacket of the mixer was heated using a heat exchanger, and 1.143 kg water was added. The water was heated to 40° C. 0.003 kg Proxel GXL was added to the mixer. 0.324 kg cellulose was added to the mixer in batches. The mixer was agitated initially at 30 RPM (5.9 Hz). After adding about 180 g cellulose, mixing speed was increased to 45 RPM (8.7 Hz). The mixture looked like a slurry. The remaining cellulose was added, and the mixture looked very clumpy. 0.028 kg Methocel A4M was added to the mixer. At the end of the addition, the mixture temperature was 42.7° C. Agitation of the mixer was increased to 60 RPM, and the mixer jacket was cooled to 5° C., reducing temperature of the mixture. Agitation was increased in stages from 60 RPM to 100 RPM and then to 200 RPM. Viscosity of the blank batch mixture was measured as 225.3 Pa·s.

### Example 5

Another experimental blank batch of adhesive bait 102 was manufactured using the 4 L Processall mixer. The batch had an expected amount of 1.5 kg and targeted 0.2% active ingredient (noviflumuron) loading by weight. The jacket of the mixer was heated using a heat exchanger, and 1.143 kg water was added. The water had a measured pH of 7.54 at 19° C. 0.003 kg Proxel GXL was added to the mixer. After adding the Proxel GXL, the water had a measured pH of 9.44 at 18° C. The mixer was agitated initially at 10 RPM (2 Hz). 0.200 kg cellulose was added to the mixer, and then the mixer was agitated at 60 RPM (12 Hz) for five minutes. Temperature of the mixture was measured at 17° C. 0.028 kg Methocel A4M was added to the mixer, and mixing continued at 60 RPM (12 Hz) for 7 minutes. Temperature of the mixture was measured at 16° C. The remaining 0.124 kg cellulose was added. Mixing continued at 60 RPM (12 Hz) for two minutes, and the mixture was heated using the jacket of the mixer. Agitation of the mixer was increased to 150 RPM (30 Hz) for 30 minutes. During this time, temperature of the mixture increased to a final value of about 52° C. After stopping the mixer, the mixture was moved/stirred manually with a spatula, and then was mixed again at 150 RPM (30 Hz) for five minutes. Final temperature of the mixture was measured at 52.7° C. Viscosity of the blank batch mixture was measured as 356.1 Pa·s.

### Example 6

Several pilot batches of adhesive bait 102 were manufactured using the 4 L Processall mixer, and are described in Examples 6-14. Each of those pilot batches had an expected amount of 2.5 kg, and initial batches targeted 0.2% active ingredient (noviflumuron) loading by weight. Blank batches substituted additional cellulose for 0.2% by weight active ingredient. Note that batches described below in connection with Examples 9-14 were targeted at 0.125% active ingredient (noviflumuron) loading by weight. Referring again to Example 6, a blank batch was created by adding 1.905 kg water to the mixer at room temperature and agitating at 10 RPM (2 Hz). 0.005 kg Proxel GXL was added, and agitation was continued at 10 RPM. 0.345 kg of cellulose was added and agitation was increased to 60 RPM (12 Hz). At this point, the mixture looked like a slurry. Next, 0.045 kg of Methocel A4M was added and agitation was increased to 150 RPM (30 Hz). The Methocel A4M began to gel somewhat at room temperature, and the mixture appeared blob-like and continued to dissolve or disperse. Next, the remaining 0.200 kg of cellulose was added, and agitation continued at 60 RPM (12 Hz). Mixing speed was increased to 150 RPM (30 Hz), and mixing continued for 20 minutes. Then, mixing speed was increased to 225 RPM (45 Hz), temperature was increased to 65° C., and mixing continued for 30 minutes. After completion, the mixture appeared crumbly and became paste-like upon application of pressure. The mixture was mixed again at 150 RPM (30 Hz) for five minutes after cooling and sitting overnight in the sealed mix chamber. The mixture became stickier and more paste-like. Viscosity of the blank batch mixture was measured as 277.7 Pa. s.

### Example 7

Another blank pilot batch of adhesive bait 102 was manufactured using the 4 L Processall mixer. Initially, 1.905 kg water and 0.005 kg Proxel GXL were added to the mixer at room temperature. The mixture was agitated at 10 RPM (2 Hz), and temperature of the mixer jacket was set to 88° C. The temperature of the mixture was raised to 82.7° C. Next, 0.045 kg of Methocel A4M was added to the mixer and agitation was increased to 150 RPM (30 Hz). The mixture was mixed for about 2 minutes, and formed a foamed but well-dispersed, cloudy liquid. Next, 0.545 kg of cellulose was added, agitation was decreased to 60 RPM (12 Hz), and the mixture was mixed for 2-5 minutes at those conditions. Next, mixing speed was increased to 150 RPM (30 Hz), and temperature of the mixer was reduced to 60° C. Mixing continued at that temperature for 12 minutes. The material was clumpy and broken, not continuous, and felt dry to the touch but water squeezed out upon application of pressure. Next, the mixer jacket was further cooled from 58° C. to 48° C., and mixing continued at 150 RPM for 18 more minutes. The mixture transitioned into a paste-like material as the temperature dropped to 36° C. After the temperature reached 36° C., mixing speed increased to 225 RPM (45 Hz) for one minute, and then increased again to 300 RPM (60 Hz) for an additional minute. After completion, the mixture had a matte finish, indicating good incorporation of water in the gel structure and indicating proper gelling of the Methocel A4M binder. Viscosity of the blank batch mixture was measured as 243.8 Pa·s.

### Example 8

A pilot batch of adhesive bait 102 was manufactured using the 4 L Processall mixer. The pilot batch had an expected amount of 2.5 kg and targeted 0.2% active ingredient (noviflumuron) loading by weight. Initially, 1.905 kg water was added to the mixer at room temperature. The mixture was agitated at 10 RPM (2 Hz), and the mixer jacket was heated using a heat exchanger. The temperature of the water raised to 84.3° C. Next, 0.005 kg Proxel GXL was added to the mixture, and agitation continued at 10 RPM (2 Hz). Next, 0.005 kg noviflumuron was added to the mixture, and mixing speed increased to 100 RPM (20 Hz). The temperature of the mixture was 85.7° C., and mixing continued for five minutes, until the noviflumuron was dispersed. Next, 0.045 kg of Methocel A4M was added to the mixer and agitation was increased to 150 RPM (30 Hz). The mixture was mixed for about 2 minutes at 85.7° C. Next, 0.540 kg of cellulose was added, and the mixture was agitated at 100 RPM during the addition. Temperature of the mixture dropped from 86° C. to 83.5° C. upon the addition of cellulose. Mixing at those conditions continued for about five minutes. Next, chilled water flow was applied to the mixer jacket and agitation speed was increased to 150 RPM. The temperature of the mixture dropped to 60° C., at which time chilled water flow was stopped. The mixture continued to be agitated for about 10 minutes, and the temperature dropped toward ambient. Next, chilled water flow was restored, and agitation continued for about 13 more minutes. Temperature dropped from 60° C. to 48° C. After completion, the mixture had a somewhat wet surface appearance, indicating poor gelation and impartial water locking between the cross-linking as the gel was forming.

An analysis was performed on the material produced in Example 8. Results of the analysis are shown below in Table 3. As shown, variability in active ingredient percent by weight was about 25%. Additionally, although target active ingredient loading was 0.2% by weight, measured % by weight is lower. Degradation in the active ingredient may be due to high pH caused by the Proxel GXL biocide or by high temperatures during processing.

TABLE 3
Analysis of Example 8 product.

| | Wt. % | Average |
|---|---|---|
| Sample | Noviflumuron | wt. % |
| Front replicate 1 | 0.154 | 0.165 |
| Front replicate 2 | 0.176 | |
| Middle replicate 1 | 0.136 | 0.138 |
| Middle replicate 2 | 0.139 | |
| Back replicate 1 | 0.175 | 0.184 |
| Back replicate 2 | 0.193 | |

### Example 9

Another pilot batch of adhesive bait 102 was manufactured using the 4 L Processall mixer. The pilot batch had an expected amount of 2.5 kg and targeted 0.125% active ingredient (noviflumuron) loading by weight. Initially, 1.905 kg water was added to the mixer at room temperature. The mixer was agitated at 10 RPM (2 Hz), and the mixer jacket was heated using a heat exchanger. The temperature of the water was raised to 85° C. Next, 0.005 kg Proxel GXL was added to the mixture, and agitation continued at 10 RPM and 86° C. Next, 0.00314 kg noviflumuron was added to the mixture, and mixing speed was increased to 30 RPM (6 Hz). Reduced mixing speed caused less bubbling as compared to the process of Example 8. Next, 0.045 kg of Methocel A4M was added to the mixer at 86° C. and agitation was increased to 100 RPM (20 Hz). The increased mixing speed caused significant bubbling. Next, 0.54186 kg of cellulose was added, and mixing speed was increased to 150 RPM (30 Hz). Temperature of the mixture at addition was 86° C. and was lowered shortly after addition. The mixture was initially mixed at 86° C. for about five minutes, and then temperature was dropped to 60° C. using cold water flow to the mixer jacket. When the mixture reached 60° C., chilled water flow stopped. Temperature of the mixture continued to drop without active temperature control for about 10 minutes, and then chilled water flow was restored. Mixing continued for about 13 minutes while the temperature continued to drop. Total mixing time was 36 minutes after the addition of all ingredients.

### Example 10

Two pilot batches of adhesive bait 102 were manufactured using the 4 L Processall mixer. Each of those pilot batches had an expected amount of 2.5 kg and targeted 0.125% active ingredient (noviflumuron) loading by weight. For each batch, 1.905 kg water was initially added to the mixer at room temperature. The mixer was agitated at 10 RPM (2 Hz), and the mixer jacket was heated using a heat exchanger. The temperature of the water was raised to 84° C. Next, 0.005 kg Proxel GXL was added to the mixer, and agitation continued at 10 RPM and 84° C. Next, 0.045 kg of Methocel A4M was added to the mixer at 84° C. and agitation was increased to 35 RPM (7 Hz). The reduced mixing speed compared to Example 8 caused less bubbling. The mixture was mixed at these conditions for five minutes to hydrate the Methocel A4M properly. 0.00314 kg noviflumuron and 0.54186 kg cellulose were placed in a jar and blended vigorously by shaking and rolling to create a dry blend. The dry blend was added to the mixer with mixing speed at 100 RPM (20 Hz) and 84° C. After adding the dry blend, mixing speed was increased to 150 RPM (30 Hz), and temperature was reduced toward 55° C. Mixing continued for about 10 minutes at those conditions. After reaching 55° C., temperature of the mixture was further reduced toward 45° C. and mixing continued at those conditions for five minutes. After reaching 45° C., mixing speed was increased to 300 RPM (60 Hz), and temperature was further reduced toward 38° C. Mixing continued for 15 minutes at those conditions. Viscosity of the second batch mixture produced in Example 10 was measured as 380.6 Pa·s.

### Example 11

Another pilot batch of adhesive bait 102 was manufactured using the 4 L Processall mixer. The pilot batch had an expected amount of 2.5 kg and targeted 0.125% active ingredient (noviflumuron) loading by weight. Initially, 1.905 kg water was added to the mixer at room temperature. The mixer was agitated at 10 RPM (2 Hz), and the mixer jacket was heated using a heat exchanger. The temperature of the water was raised to 84° C. Next, 0.005 kg Proxel GXL was added to the mixer, and agitation continued at 10 RPM and 84° C. Next, 0.045 kg of Methocel A4M was added to the mixer at 84° C. and agitation was increased to 35 RPM (7 Hz). The reduced mixing speed compared to Example 8 caused less bubbling. The mixture was mixed at these conditions for five minutes to hydrate the Methocel A4M properly. 0.00314 kg noviflumuron and 0.54186 kg cellulose were placed in ajar and blended vigorously by shaking and rolling to create a dry blend. The dry blend was added to the mixer with mixing speed at 300 RPM (60 Hz) and temperature of the mixture at 84° C. After adding the dry blend, mixing continued at 300 RPM for about two minutes. After the cellulose and noviflumuron were added, the mixture had a broken, wet-cotton-like appearance. Active cooling was applied to the mixer jacket to reduce mixture temperature toward 43° C. Mixing continued for about 10 minutes at 300 RPM as the temperature dropped. As temperature begins to drop, the broken, wet-cotton appearance of the mixture started to smooth. After reaching 43° C., active cooling of the mixer jacket was stopped. Mixing continued at 300 RPM for 20 minutes, and the temperature continued to drop without active temperature control. A smooth, uniform paste formed as the mixture was cooled and agitated simultaneously. After completion, viscosity of the batch mixture was measured as 447.6 Pa. s.

### Example 12

Another pilot batch of adhesive bait 102 was manufactured using the 4 L Processall mixer. The pilot batch had an expected amount of 2.5 kg and targeted 0.125% active ingredient (noviflumuron) loading by weight. Initially, 1.905 kg water was added to the mixer at room temperature. The mixer was agitated at 10 RPM (2 Hz), and the mixer jacket was heated using a heat exchanger. The temperature of the water was raised to 84° C. Next, 0.005 kg Proxel GXL was added to the mixer, and agitation continued at 10 RPM and 84° C. Next, 0.045 kg of Methocel A4M was added to the mixer at 84° C. and agitation was increased to 35 RPM (7 Hz). The reduced mixing speed compared to Example 8 caused less bubbling. The mixture was mixed at these conditions for five minutes to hydrate the Methocel A4M properly. 0.00314 kg noviflumuron and 0.54186 kg cellulose were placed in ajar and blended vigorously by shaking and rolling to create a dry blend. The dry blend was added to the mixer with mixing speed at 300 RPM (60 Hz) and temperature of the mixture at 84° C. After adding the dry blend, mixing continued at 300 RPM for about two minutes. Active cooling was applied to the mixer jacket to reduce mixture temperature toward 43° C. Mixing continued for about 13 minutes at 300 RPM as the temperature dropped. After reaching 43° C., active cooling of the mixer jacket was stopped. Mixing continued at 300 RPM for 17 minutes, and the temperature continued to drop without active temperature control.

During the process of Example 12, mixing was stopped at 20 minutes to stir manually with the emergency lock employed. Additionally, the mixer was not completely cleaned between manufacturing the batches of Examples 9-12. Based on mass balance, the batch of Example 12 included about 200 g of the batches of Examples 9-11 blended back into the new batch. The 200 g of material that was reprocessed with virgin material shows a possibility of successful re-work (at about 7.5% re-work material added to 92.5% virgin material). Thus, in case of issues during production, batches may be re-worked to a certain percentage to salvage any out-of-specification material.

### Example 13

Another pilot batch of adhesive bait 102 was manufactured using the 4 L Processall mixer. The pilot batch had an expected amount of 2.5 kg and targeted 0.125% active ingredient (noviflumuron) loading by weight. Initially, 1.905 kg water was added to the mixer at room temperature. The mixture was agitated at 10 RPM (2 Hz), and the mixer jacket was heated using a heat exchanger. The temperature of the water was raised to 84° C. Next, 0.005 kg Proxel GXL was added to the mixer, and agitation continued at 10 RPM (2 Hz) and 84° C. Next, 0.045 kg of Methocel A4M was added to the mixer at 84° C. and agitation was increased to 35 RPM (7 Hz). The reduced mixing speed compared to Example 8 caused less bubbling. The mixture was mixed at these conditions for five minutes to hydrate the Methocel A4M properly. 0.00314 kg noviflumuron and 0.54186 kg cellulose were placed in ajar and blended vigorously by shaking and rolling to create a dry blend. The dry blend was added to the mixer with mixing speed at 300 RPM (60 Hz) and temperature of the mixture at 84° C. After adding the dry blend, mixing continued at 300 RPM for about twenty minutes. Active cooling was then applied to the mixer jacket to reduce mixture temperature toward 43° C., and after reaching 43° C., active cooling of the mixer jacket was stopped. Mixing continued at 300 RPM during the temperature drop.

An analysis was performed on the material produced in Example 13. Results of the analysis are shown below in Table 4. As shown, variability in active ingredient percent by weight was about 1.67% between the lowest and highest average weight percentages of samples selected from different parts of the same batch. Accordingly, homogeneity of the material produced in Example 13 is improved compared to the material produced in Example 8.

TABLE 4
Analysis of Example 13 product.

| | Wt. % | Average |
|---|---|---|
| Sample | Noviflumuron | wt. % |
| Sample 1, replicate 1 | 0.107 | 0.106 |
| Sample 1, replicate 2 | 0.106 | |
| Sample 2, replicate 1 | 0.107 | 0.108 |
| Sample 2, replicate 2 | 0.109 | |
| Sample 3, replicate 1 | 0.103 | 0.108 |
| Sample 3, replicate 2 | 0.113 | |

### Example 14

After producing pilot batches as described above in connection with Examples 9-13, all of those pilot batches described above in connection with Examples 9-13 were combined together and mixed well to generate a composite batch. An analysis was performed on the composite batch, and results of that analysis are shown below in Table 5. As shown, variability in active ingredient percent by weight was about 2.71% between the lowest and highest average weight percentages of samples selected from different parts of the composite batch. Also, viscosity of the composite batch mixture was measured as 289.4 Pa·s.

TABLE 5
Analysis of Example 14 composite batch.

| | Wt. % | Average |
|---|---|---|
| Sample | Noviflumuron | wt. % |
| Bottom replicate 1 | 0.098 | 0.102 |
| Bottom replicate 2 | 0.105 | |
| Middle replicate 1 | 0.088 | 0.099 |
| Middle replicate 2 | 0.110 | |
| Top replicate 1 | 0.101 | 0.101 |
| Top replicate 2 | 0.101 | |

| | |
|---|---|
| Composite batch average | 0.100 |

### Example 15

An experiment was run to determine whether adhesive bait is sufficiently palatable to subterranean termites when placed in above-ground baiting situations, to determine whether adhesive bait eliminated termite colonies, and to compare termite feeding for blank adhesive bait against blank preferred texture cellulose (PTC) bait when installed in above-ground stations onto termite-infested trees. In the experiment, adhesive bait was applied to 10 trees located in New Orleans, Louisiana. The adhesive bait contained 0.1% noviflumuron (% wet weight). For background termite activity monitoring, stations with electronic sensing protection (ESP) wood monitors were installed around known infested trees at 1-2 foot intervals, resulting in a circular row of 4-6 stations. DNA samples of termites were taken from stations and trees.

Adhesive bait was applied into areas of activity within or on each tree. For some trees, adhesive bait was injected into the tree galleries with a caulk gun. Holes were drilled out into the tree and the adhesive bait was injected. For some trees, adhesive bait was applied onto active mud tubes by breaking the mud tube and applying a deposit of adhesive bait into the broken mud tube area. For some trees, the adhesive bait was applied at the base of the tree in a dug out area. To protect the adhesive bait, the adhesive bait was covered by a black plastic cover, tape, or leaves and soil, depending on operator discretion.

The amount applied to each tree was estimated. Trees baited with less than 400 g adhesive bait had additional adhesive bait applied at subsequent visits (retreats). Trees baited with more than 400 g adhesive bait did not have additional bait applied. At 1 month, 2 months, and 3 months, assessments were made for each tree of the estimated percentage of adhesive bait deposit consumed. An endoscope was used to help estimate consumption. Assessments were made for each tree regarding whether termites were present and an estimate of relative numbers (e.g., some or many). An endoscope was used to help determine if termites were present and to determine a relative estimate. Assessments were made for each tree regarding whether the colony was eliminated and, if so, the days to elimination (DTE). For trees, days to elimination were measured as the number of days from first installation of adhesive bait until no termites were found in the tree and in stations around the tree.

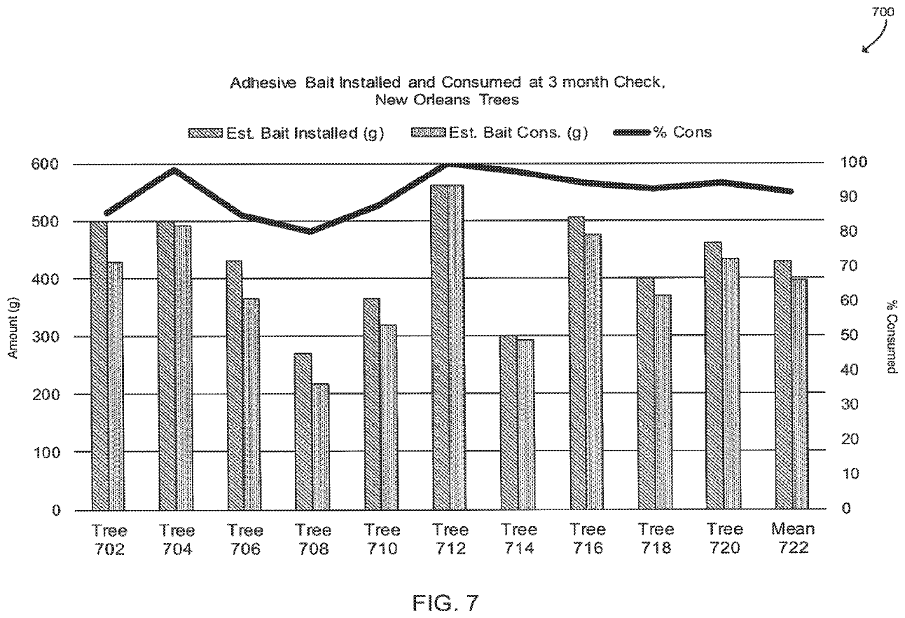

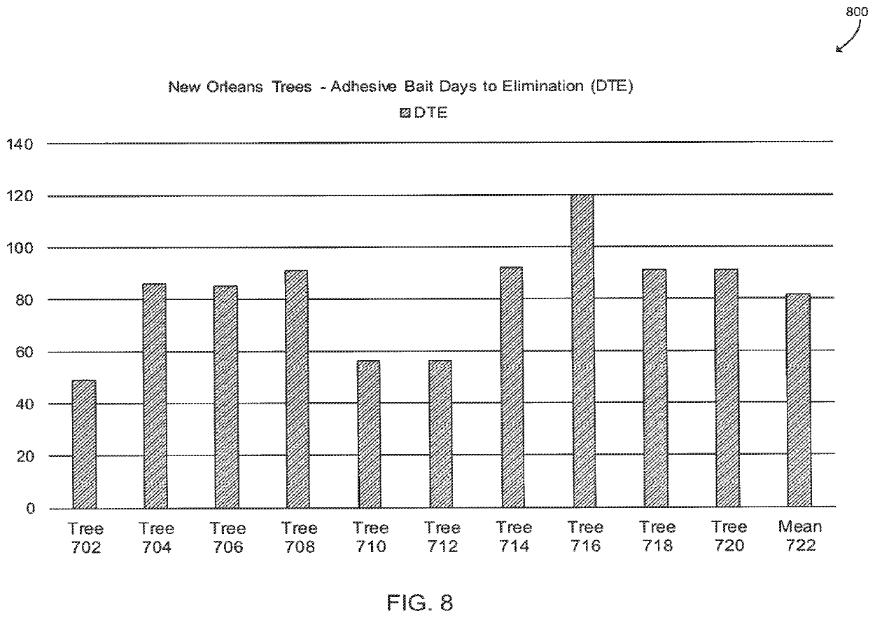

Referring now to FIG. 7, chart 700 illustrates estimated adhesive bait installed, estimated adhesive bait consumed at the 3-month check, and percentage of bait consumed for the 10 trees 702 to 720 that were baited as described above. The chart 700 also illustrates a mean 722 of the trees 702 to 720. Trees 704, 712, 716, 718, 720 were baited a single time, and trees 702, 706, 708, 710, 714 were also retreated at the 1-month check. Referring now to FIG. 8, chart 800 illustrates days to elimination (DTE) for each of the trees 702 to 720 and the mean 722.

As shown, the colony was eliminated for each tree. For all trees, mean DTE was 81.7 days, and mean percentage of adhesive bait consumed was 91.4%. For trees that were retreated, mean DTE was 74.6 days and mean percentage of adhesive bait consumed was 87.1%. For trees that were treated a single time, mean DTE was 88.8 days and mean percentage of adhesive bait consumed was 94.7%.

### Example 16

In another aspect of the experiment described above in connection with Example 15, adhesive bait was applied to 5 structures located in New Orleans, Louisiana. The adhesive bait contained 0.1% noviflumuron (% wet weight). Adhesive bait was applied to areas of known activity within each structure. For some active areas, adhesive bait was injected into the active areas with a caulk gun. For some active areas, adhesive bait was applied onto active mud tubes by breaking the mud tube and applying a deposit of adhesive bait into the broken mud tube area. To protect the adhesive bait, the adhesive bait was covered by a black plastic cover, tape, or other material such as soil if at the base of the structure.

The amount applied to each structure was estimated, including initial treatment and retreats. Assessments were made for each structure of the estimated percentage of adhesive bait deposit consumed, whether termites were present and an estimate of relative numbers (e.g., some or many), whether the colony was eliminated, and the days to elimination (DTE). For structures, days to elimination were measured as the number of days from first installation of adhesive bait until no termites were found in the structure after a structural inspection.

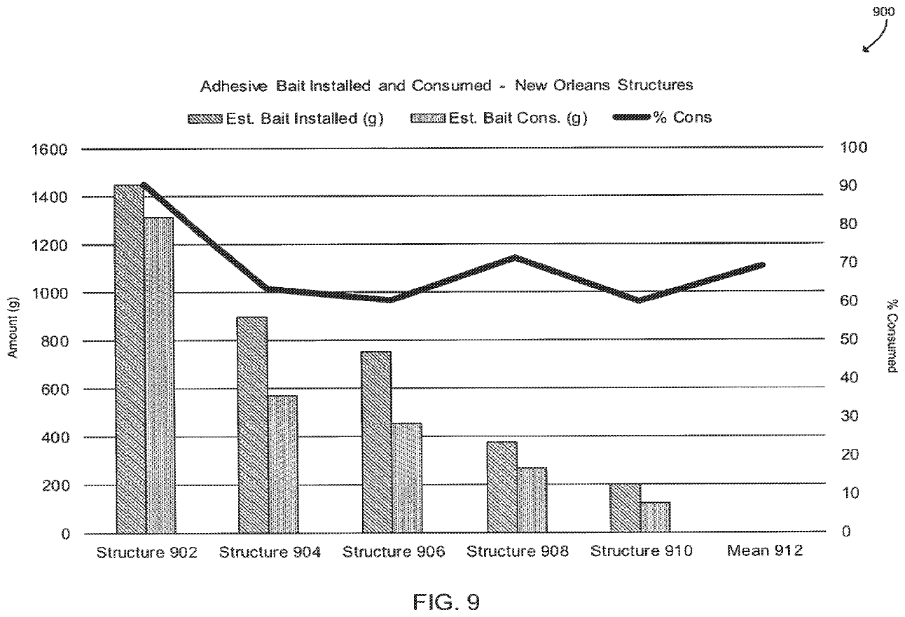

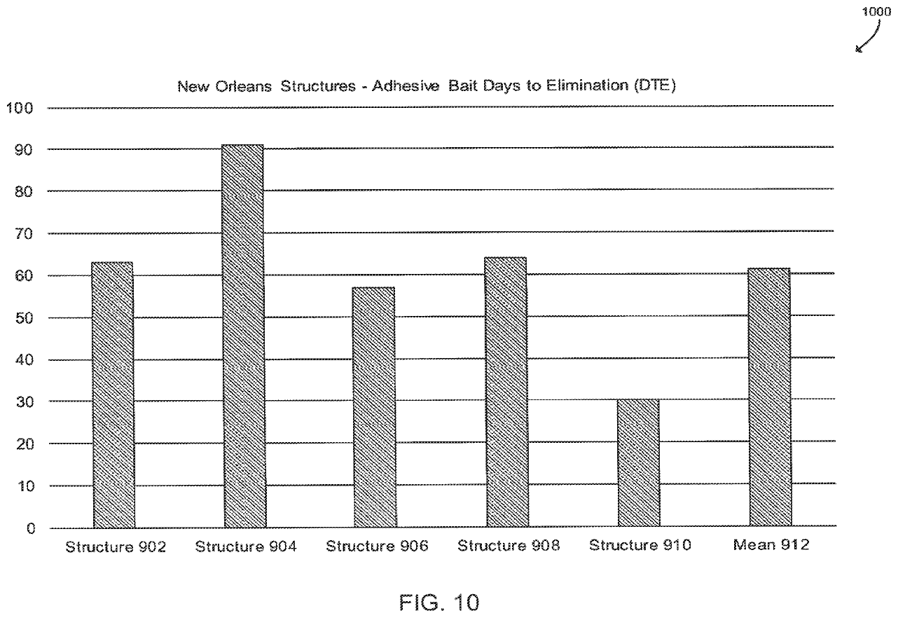

Referring now to FIG. 9, chart 900 illustrates estimated adhesive bait installed, estimated adhesive bait consumed, and percentage of bait consumed for the five structures 902 to 910 that were baited as described above. The chart 900 also illustrates a mean 912 of the structures 902 to 910. Structure 910 was baited a single time, and structures 902, 904, 906, 908 were also retreated. Referring now to FIG. 10, chart 1000 illustrates days to elimination (DTE) for each of the structures 902 to 910 and the mean 912. As shown, the colony was eliminated for each structure. DTE ranged from 30 days to 91 days, and the average DTE was 61 days.

Based on those experiments, it was concluded that adhesive bait was readily accepted and heavily consumed by termites. Bait on surfaces that was not consumed tended to harden and was not consumed as readily; covering the bait with plastic or tape improved consumption. It was also concluded that adhesive bait eliminated colonies of C. formosanus termites with similar effectiveness to existing baits.

### Example 17

As another aspect of the experiments described above in connection with Examples 15 and 16, blank adhesive bait (with no active ingredient) was compared to blank preferred texture cellulose (PTC) bait briquettes. Flexible plastic packets were prepared that each included either 100 g blank adhesive bait or 100 g blank PTC. One packet of blank adhesive bait and one packet of blank PTC were installed side by side on each tree onto active termite tunnels or the base of the tree. One set of six trees was installed, followed by another set of five trees. Assessments were made of whether each packet had termite activity (a hit), estimated termite numbers, and percentage consumption. Data for certain packets was unavailable due to vandalism or other causes. For the first set of trees, of the five blank adhesive bait packets with valid data, 5/5 packets were hit, with an average consumption of 100%. Of the four blank PTC packets with valid data, 4/4 packets were hit, with an average consumption of 77.5% (three packets at 100% consumption and one packet at 10% consumption). For the second set of trees, 4/5 blank adhesive bait packets were hit, with an average consumption of 69.75%, and 4/5 blank PTC packets were hit, with an average consumption of 67.5%. Based on those experiments, it was concluded that blank adhesive bait was consumed similarly to and numerically slightly more than blank PTC.

### Example 18

An experiment was run to determine whether adhesive bait eliminated termite colonies for multiple termite species, including R. hesperus and R. flavipes. In the experiment, adhesive bait was applied to nine structures located in California, Texas, and Indiana. The adhesive bait contained 0.18% noviflumuron (% wet weight). Prior to baiting, a thorough structural inspection was performed to identify all visible areas of termite activity. Termite DNA samples were taken from all areas of termite activity. Adhesive bait was applied to areas of known activity using a caulk gun. The amount of adhesive bait applied was estimated based on 250 g adhesive bait per tube (i.e., cartridge). Deposits of adhesive bait were injected into active areas. Deposits of adhesive bait were applied onto active mud tubes by breaking the mud tube and applying a deposit of adhesive bait into the broken mud tube area. If less than ½ of one tube of adhesive bait (i.e., about 125 g) was initially applied and the bait deposits were consumed at subsequent monthly checks, additional adhesive bait could be applied. No more than two tubes (500 g) adhesive bait could be applied to each structure. Adhesive bait deposits were covered and protected by a black plastic cover, tape, or other cover such as soil if at the base of a structure.

The amount applied to each structure was estimated. Assessments were made for each structure of the estimated percentage of adhesive bait deposit consumed. An endoscope was used to help estimate consumption. Assessments were made for each structure regarding whether termites were present and an estimate of relative numbers (e.g., some or many). An endoscope was used to help determine if termites were present and to determine a relative estimate. Assessments were made for each structure regarding whether the colony was eliminated and the days to elimination (DTE). For structures, days to elimination were measured as the number of days from first installation of adhesive bait until no termites were found in the structure after a structural inspection.

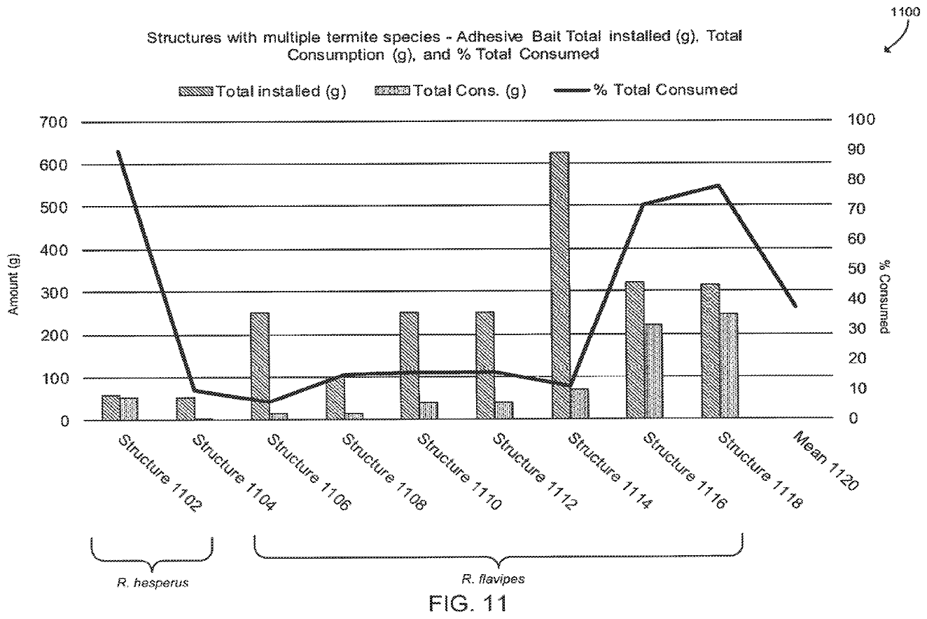

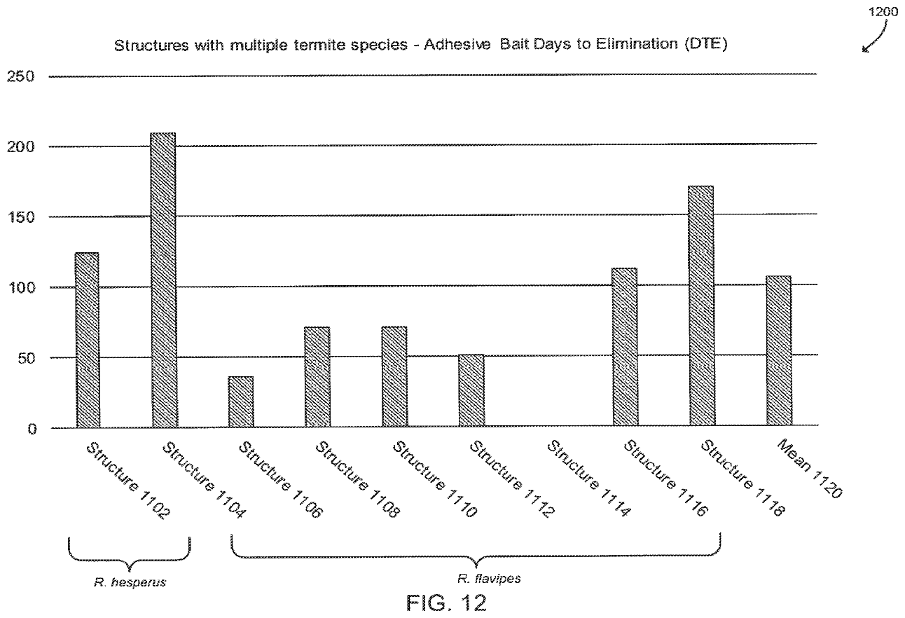

Referring now to FIG. 11, chart 1100 illustrates estimated adhesive bait installed, estimated adhesive bait consumed, and percentage of bait consumed for the nine structures 1102 to 1118 that were baited as described above. The chart 1100 also illustrates a mean 1120 of the structures 1102 to 1118. Structures 1102, 1104 were infested with R. hesperus, and structures 1106, 1108, 1110, 1112, 1114, 1116, 1118 were infested with R. flavipes. Referring now to FIG. 12, chart 1200 illustrates days to elimination (DTE) for each of the structures 1102 to 1118 the mean 1120.

As shown, the colony was eliminated for each structure except for structure 1114, which still had soldiers present at a 5-month check. For all eliminated structures, mean DTE was 105.5. Mean DTE for structures with R. hesperus was 166.5 days, and mean DTE for eliminated structures with R. flavipes was 85.17 days.

### Example 19

An experiment was run to determine how much adhesive bait was required for colony elimination. Three treatment rates were tested: ½ tube of adhesive bait (125 g), 1 tube of adhesive bait (250 g), and 1½ tubes of adhesive bait (375 g). The adhesive bait was formulated with 0.2% by weight noviflurumon. The treatments were tested in New Orleans, Louisiana against colonies of C. formosanus. Six replicates of each treatment rate were applied to trees (18 trees total). Each treatment rate was also installed in a structure (three structures).

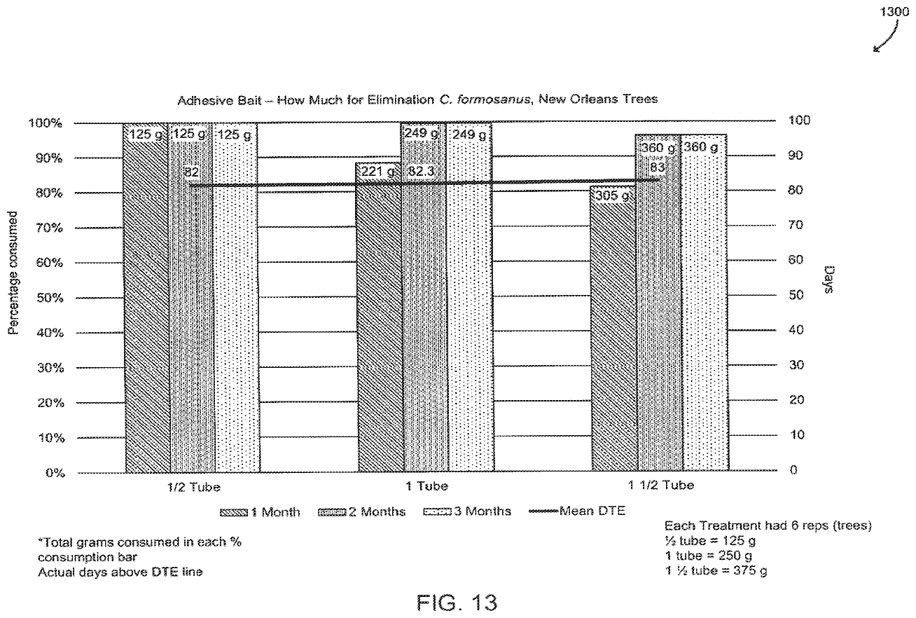

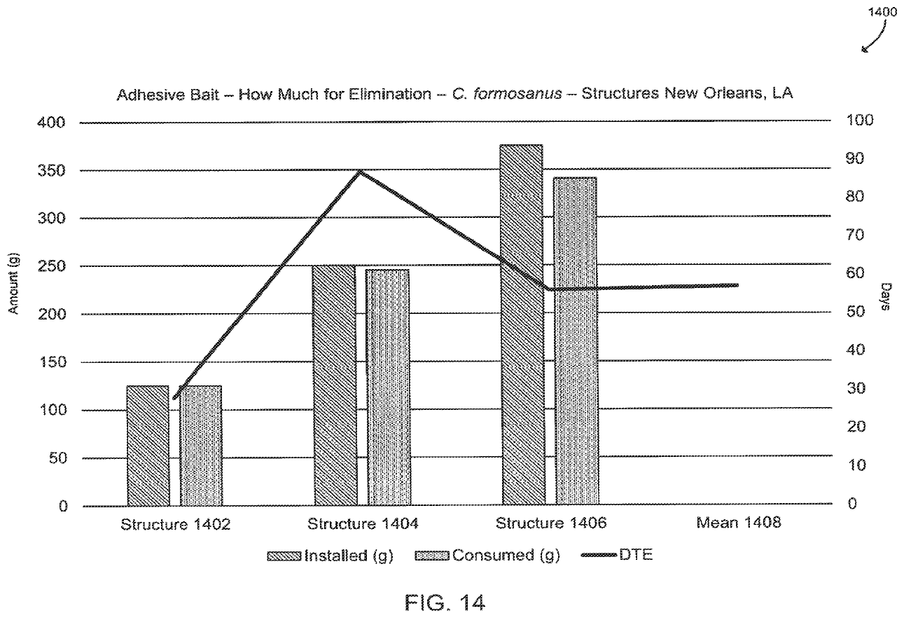

Referring now to FIG. 13, chart 1300 illustrates the amount of bait consumed for each treatment rate at 1 month, 2 months, and 3 months, and the mean days to elimination (DTE) for each treatment rate for the trees described above. As shown, mean DTE for 125 g adhesive bait was 82 days, mean DTE for 250 g adhesive bait was 82.3 days, and mean DTE for 375 g adhesive bait was 83 days. Referring now to FIG. 14, chart 1400 illustrates amount of bait installed and consumed for each structure 1402, 1404, 1406, and DTE for structures 1402, 1404, 1406, and a mean DTE 1408 for structures 1402, 1404, 1406. Mean DTE for eliminated structures was 57 days.

Based on those experiments, it was concluded that all three treatment rates (125 g, 250 g, and 375 g) were adequate to eliminate colonies. For trees, there was no difference between the mean DTE for each treatment rate. Lower treatment rates may also be effective for eliminating colonies.

### Example 20

An experiment was run to determine whether adhesive bait (at 0.18% by weight noviflumuron) used together with a commercially available Recruit AG FLEXPACK solid briquette bait packet (0.5% by weight noviflumuron) eliminates colonies faster than Recruit AG FLEXPACK alone in structures and/or trees, and to determine whether hit rates for adhesive bait used together with Recruit AG FLEXPACK are faster than Recruit AG FLEXPACK alone in structures and/or trees. For the experiment, two treatments were performed. In one treatment, up to 1/10 tube (25 g) adhesive bait was applied into areas of termite activity, and then a Recruit AG FLEXPACK was installed over the adhesive bait treatment. In the other treatment, a Recruit AG FLEXPACK was installed into areas of termite activity, with no adhesive bait.

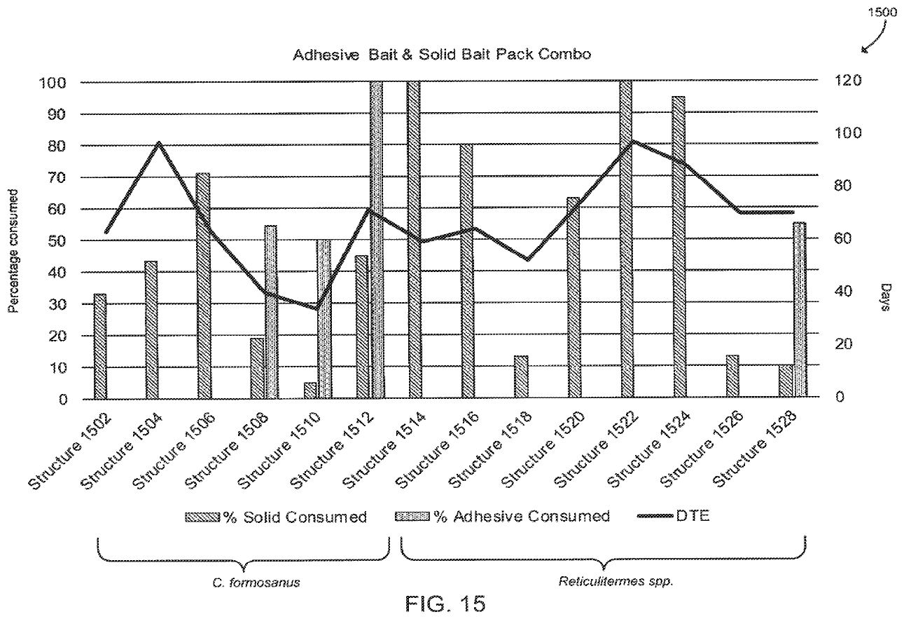

Referring now to FIG. 15, chart 1500 illustrates percent solid bait consumed, percent adhesive bait consumed, and days to elimination (DTE) for test structures 1502 to 1528. Structures 1502 to 1512 were infested with C. formosanus, and structures 1514 to 1528 were infested with Reticulitermes spp. Structures 1502, 1504, 1506, 1514, 1516, 1518, 1520 were treated with Recruit AG FLEXPACK only, and structures 1508, 1510, 1512, 1522, 1524, 1526, 1528 were treated with a combination of adhesive bait and Recruit AG FLEXPACK. For structures infested with C. formosanus, mean DTE for Recruit AG FLEXPACK only was 74.33 days, and mean DTE for adhesive bait combined with Recruit AG FLEXPACK was 48.33 days. For those structures infested with C. formosanus, hit rate during the first week was 60% for Recruit AG FLEXPACK and 57.14% for adhesive bait combined with Recruit AG FLEXPACK. For structures infested with Reticulitermes spp., mean DTE for Recruit AG FLEXPACK only was 62.3 days, and mean DTE for adhesive bait combined with Recruit AG FLEXPACK was 81.5 days. For those structures infested with Reticulitermes spp., hit rate during the first week was 75% for Recruit AG FLEXPACK and 81.8% for adhesive bait combined with Recruit AG FLEXPACK.

Based on those experiments, it was concluded that there was no significant difference in DTE between Recruit AG FLEXPACK and combined adhesive bait and Recruit AG FLEXPACK. Additionally, hit rates (percent hit and time to hit) did not appear to be different between Recruit AG FLEXPACK and combined adhesive bait and Recruit AG FLEXPACK.

### Example 21

Another experiment was run to determine how much adhesive bait was required for colony elimination. Three treatment rates were tested: 18 tube of adhesive bait (31.25 g), ¼ tube of adhesive bait (62.5 g), and ½ tube of adhesive bait (125 g). The adhesive bait used in the experiment was formulated with 0.1% by weight noviflumuron. The treatments were tested in New Orleans, Louisiana against colonies of C. formosanus. Six replicates of each treatment rate were applied to trees (18 trees total).

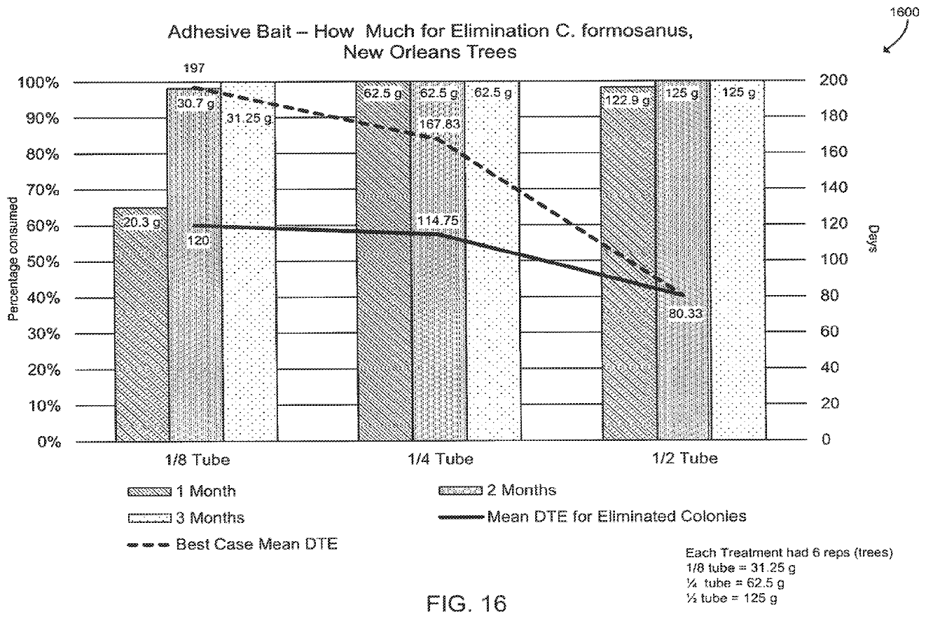

Referring now to FIG. 16, chart 1600 illustrates the amount of bait consumed for each treatment rate at 1 month, 2 months, and 3 months, the mean days to elimination (DTE) for eliminated colonies for each treatment rate, and the best case mean DTE for each treatment rate for the trees described above. For 31.25 g adhesive bait applied (⅛ tube), three out of six trees had colonies eliminated after eight months (50% eliminated). For those colonies that were eliminated, the mean DTE was 120 days, and the best case mean DTE (if all colonies are eliminated by about nine months after application) is 197 days. For 62.5 g adhesive bait applied (¼ tube), four out of six trees had colonies eliminated after eight months (66.7% eliminated). For those colonies that were eliminated, the mean DTE was 114.75 days, and the best case mean DTE (if all colonies are eventually eliminated by the end of the study) is 167.83 days. For 125 g adhesive bait applied (½ tube), all six trees had colonies eliminated after eight months (100% eliminated). For those colonies that were eliminated, the mean DTE was 80.33 days, and because all colonies were eliminated, the best case mean DTE was also 80.33 days.

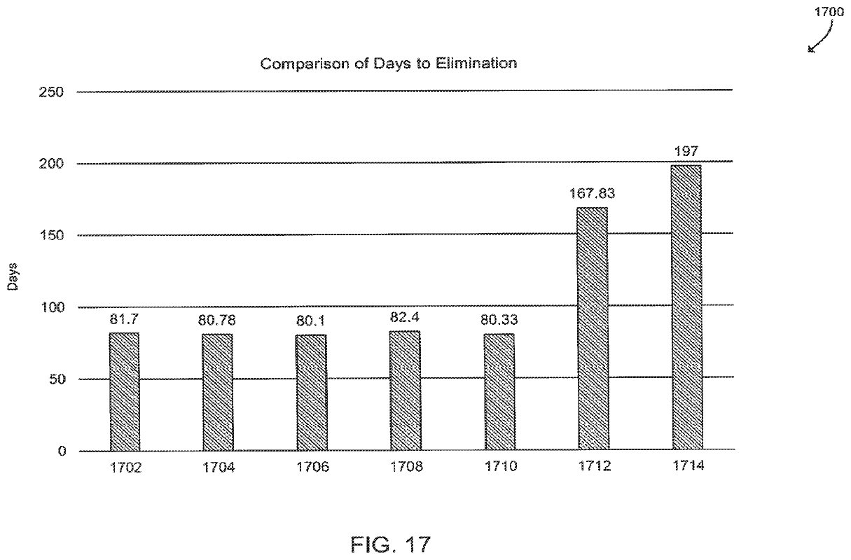

Referring now to FIG. 17, chart 1700 illustrates the mean DTE determined in the current experiment compared to results of previous experiments. Bar 1702 illustrates mean DTE for a trial of adhesive bait applied to termite-infested trees. Bar 1704 illustrates mean DTE for a trial of solid-matrix bait used with termite-infested trees. Bar 1706 illustrates mean DTE for a trial of solid-matrix bait briquettes in a flexible packet applied to structures. Bar 1708 illustrates mean DTE for applications of ½ tube, 1 tube, and 1½ tube of adhesive bait to infested trees as described above in connection with Example 19. Bar 1710 illustrates mean DTE for application of ½ tube of 0.1% by weight noviflumuron to infested trees as described in the current experiment. Bar 1712 illustrates the best-case mean DTE that is possible for application of ¼ tube of 0.1% by weight noviflumuron to infested trees as described in the current experiment. Bar 1714 illustrates the best-case mean DTE that is possible for application of ⅛ tube of 0.1% by weight noviflumuron to infested trees as described in the current experiment. As shown in FIG. 17, mean DTE for bars 1702 through 1710 (including the ½ tube treatment rate at 0.1% by weight noviflumuron) were about 80 days. Best-case mean DTE for the lower treatment rates shown in bars 1712, 1714 were higher. Additionally, the values of mean DTE for bars 1712, 1714 may increase as all colonies were not eliminated after eight months, as described above.

Based on those experiments, it was concluded that the 125 g treatment rate at 0.1% by weight noviflumuron was adequate to eliminate colonies. It was further concluded that the 31.25 g and 62.5 g treatment rates at 0.1% by weight noviflumuron did not compare favorably to the 125 g treatment or to treatments in previous experiments.

### Example 22

An experimental scaled-up lead batch of adhesive bait 102 was manufactured using a 140 L mixer available commercially from Processall. The mixer provided plow baffle action mixer with speed control and temperature control. The lead batch ingredient amounts were determined by scaling the amounts used in the batch described above in connection with Example 13, but targeting one half the scaled amount of Proxel GXL biocide. Process times for the lead batch were also scaled by a factor of 2.5 to 5. The lead batch had an expected amount of 80 kg and targeted 0.21% active ingredient (noviflumuron) loading by weight. Initially, 60.8647 kg water was added to the mixer at room temperature. The mixture was agitated at 5.7 RPM (1.9 Hz), and the mixer jacket was heated using a heat exchanger. The temperature of the water was raised to 84° C. Next, 0.0800 kg Proxel GXL was added to the mixer, and agitation continued at 5.7 RPM (1.9 Hz) and 84° C. Next, 0.3353 kg noviflumuron multi-use concentrate (MUC) was added to the mixer at 84° C. and agitation continued at 5.7 RPM (1.9 Hz). The MUC concentrate has a concentration of 50.1% and thus includes 0.1680 kg noviflumuron. The mixture was mixed for about 12.5 minutes. Next, 1.4400 kg of Methocel A4M was added to the mixer at 84° C. and agitation was increased to 19.8 RPM (7 Hz). The reduced mixing speed compared to Example 8 caused less bubbling. After three minutes, some Methocel A4M was stuck to walls of the mixer vessel and was not fully hydrated or dispersed. Mixing was ramped up to 69.6 RPM (25 Hz) to let water splashes capture material from the vessel walls. At 9.5 minutes, all Methocel A4M was completely hydrated, and the mixture was a uniform, milky liquid. The mixture was mixed at these conditions for 12.5 minutes to hydrate the Methocel A4M properly. 17.2800 kg cellulose was added in batches at a temperature of the mixture at 84° C. 12 kg were added at 19.8 RPM (7 Hz) in seven minutes. After 9 kg of cellulose was added, the mixture looked like a slurry, and agitation was kept at 7 Hz to avoid leakage from the mixing vessel. When the added amount of cellulose reached 12 kg, the mixture looked cotton-like and agitation was increased. After 12 kg of cellulose was added in 7 minutes, agitation was increased to 83.4 RPM (30 Hz). The remainder of the cellulose was added at this agitation speed. Total time for addition of cellulose was about 15 minutes. After adding all cellulose, mixing was increased to 166 RPM (60 Hz) for about twenty minutes. Active cooling was then applied to the mixer jacket to reduce mixture temperature toward 43° C., and after reaching 43° C., active cooling of the mixer jacket was stopped. After about an hour of cooling, the mixture reached about 43° C. The temperature of the mixture reached 35° C. after over 1 hour, 30 minutes. Mixing continued at 166 RPM during the temperature drop and for about 2 hours after reaching room temperature.

Samples of the material were stored at various temperatures for various amounts of time and were subject to freeze-thaw cycles. Viscosity of certain samples were tested. Results of that analysis are shown below in Table 6. As shown, the lead batch after 2 weeks storage at room temperature had a viscosity of 1814 Pa·s, which is usable with applicator devices.

TABLE 4
Analysis of Example 22 product.

| Sample | Viscosity (Pa · s) |
|---|---|
| 2 weeks, room temperature | 1841 |
| 2 weeks, 54° C. | 2150 |
| 2 weeks, 80° C. | 9893 |
| 4 weeks, 54° C. | 1867 |
| 4 weeks, freeze-thaw | 2981 |
| 8 weeks, room temperature | 2717 |
| 8 weeks, 40° C. | 4379 |
| 8 weeks, 54° C. | 8032 |
| 8 weeks, freeze-thraw | 3045 |

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A composition of matter comprising:
an active ingredient comprising a chitin synthesis inhibitor;
a binder;
a filler comprising a cellulosic food material palatable to termites; and
a solvent;
wherein the composition has a viscosity of at least about 200 Pa·s.

2. The composition of matter of claim 1, wherein the composition has a viscosity of between about 200 Pa·s and 500 Pa·s.

3. The composition of matter of claim 2, wherein the composition has a viscosity of between about 400 Pa·s and 500 Pa·s.

4. The composition of matter of claim 1, wherein the composition has a viscosity of between about 200 Pa·s and 3000 Pa·s.

5. The composition of matter of claim 1, wherein the composition has a viscosity that is adapted to flow through an applicator device.

6. The composition of matter of claim 5, wherein the applicator device comprises a caulk gun and cartridge assembly or a squeeze tube.

7. The composition of matter of claim 1, wherein the active ingredient comprises noviflumuron.

8. The composition of matter of claim 7, wherein the binder comprises methylcellulose, wherein the filler comprises alpha cellulose, and wherein the solvent comprises water.

9-10. (canceled)

11. The composition of matter of claim 1, wherein the active ingredient comprises hexaflumuron.

12. The composition of matter of claim 1, further comprising a biocide.

13. The composition of matter of claim 12, wherein the biocide comprises an aqueous dipropylene glycol solution of 1,2-benzisothiazolin-3-one.

14. The composition of matter of claim 1, wherein the active ingredient comprises between about 0.1% and 0.2% by weight of the composition.

15. The composition of matter of claim 1, wherein the binder combined with the filler comprise between about 24% and 30% by weight of the composition.

16-18. (canceled)

19. A method comprising:
heating water in a vessel to a first predetermined temperature;
adding a biocide to the water in the vessel;
adding a binder to the water in the vessel;
mixing the biocide and the binder in the vessel at the first predetermined temperature to generate a first component, wherein the first predetermined temperature is above a gelation temperature of the binder;
dry blending an active ingredient and a filler to generate a second component, wherein the active ingredient comprises a chitin synthesis inhibitor;
adding the second component to the first component in the vessel at the first predetermined temperature;
mixing the first component and the second component in the vessel; and
reducing temperature of the first component and the second component from the first predetermined temperature to a second predetermined temperature while mixing the first component and the second component, wherein the second predetermined temperature is below the gelation temperature of the binder.

20. The method of claim 19, wherein the binder comprises methylcellulose, the filler comprises alpha cellulose, and the active ingredient comprises noviflumuron.

21. The method of claim 19, wherein the first predetermined temperature comprises between about 82° C. to 85° C.

22. (canceled)

23. The method of claim 19, wherein the second predetermined temperature comprises between about 43° C. to 45° C.

24. (canceled)

25. The method of claim 19, wherein:
mixing the biocide and the binder in the vessel comprises mixing at a first mixing speed; and
mixing the first component and the second component in the vessel comprises mixing at a second mixing speed, wherein the second mixing speed is higher than the first mixing speed.

26-29. (canceled)

30. The method of claim 19, further comprising:
stopping active temperature control of the vessel in response to reducing temperature to the second predetermined temperature; and
mixing the first component and the second component after stopping the active temperature control.

31. (canceled)

32. The method of claim 19, wherein the vessel comprises a high shear mixer.

33-92. (canceled)
